(19) United States
(12) Patent Application Publication
(10) Pub. No.: US 2003/0223579 A1
(43) Pub. Date: Dec. 4, 2003

(54) Secure and linear public-key cryptosystem based on parity-check error-correcting

(76) Inventors: Eran Kanter, El-Kana (IL); Ido Kanter, Rehovot (IL)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/169,468

(22) PCT Filed: Dec. 28, 2000
(86) PCT No.: PCT/IL00/00865

(30) Foreign Application Priority Data
Jul. 13, 2000 (IL) 137309
Oct. 22, 2000 (IL) 139186

(51) Int. Cl. H04K 1/00

(52) U.S. Cl. 380/28

(57) ABSTRACT

A method for a secure public key cryptography employing a parity check error-correcting code, and noise signals, comprises a) creating a communication channel; b) providing a set of private cryptographic keys which are assigned to each of the entities utilizing said secure public cryptography, wherein each of said private cryptographic keys may be accessed only by the entity it was assigned to; c) providing a set of public cryptographic keys assigned to entities utilizing said secure public-key cryptography; and d) providing a set of random private noise signals, or generating the same using a random private noise signal generator; the method further comprises ciphering vectors of information by adding a noise signal to the information vector before encryption and/or after the encryption.

### FIELD OF THE INVENTION

The present invention relates to cryptographic methods based on error-correcting codes. More particularly, the invention relates to a method and apparatus for encryption/decryption, digital signature, authentication, and other tasks of the secured channel exemplified by Gallager-type parity-check error-correcting codes.

### BACKGROUND OF THE INVENTION

Cryptography is a type of transformation applied to transmitted information in order to conceal its meaning (ciphering) and prevent unauthorized entities from revealing the transmission content. At present, cryptosystems are widely used in applications in which a strong demand exists for high security, and wherein transmission authentication and its source identification must be guaranteed.

In general, when it is desired to establish a secure communication channel, the parties that are involved agree on a ciphering algorithm or on a cryptographic key (that is actually utilized to perform the encryption). The algorithm or the cryptographic keys are utilized to encrypt the information prior to its transmission on the transmitting side, and later for decrypting the received transmission on the receiving side. Decryption is utilized to reveal the transmitted information, and therefore it is knowledge that should be in the possession of an authorized party only.

In other words, cryptosystems provide means for concealing the content of the transmitted information (usually plaintext) from unauthorized parties, who may eavesdrop on the communication channel, or accidentally receive the encrypted transmission. Moreover, the ciphering methods are specially designed such that to perform decryption without the knowledge of the ciphering algorithm or the cryptographic private key, is very difficult, most likely impossible.

The massive growth in electronic communication today has led to an increased reliance on cryptography. In fact, it is cryptography that enables to establish a digital (and analogue) secured communication, identification and authentication of the transmitted information. All of which makes it impossible for opponents (e.g., hackers) to listen to secured phone conversations, tap into cable companies, and make transactions in bank accounts. Other possible attacks, frequently employed by disrupters, involve, for instance, corrupting, replacing, and/or repeating transmission blocks. However, most of the conventional cryptographic methods do not provide an adequate protection from such kinds of opponents attacks.

Many of the cryptographic methods that are utilized today are based on the so-called public-key cryptography. Public-key cryptography provides the means to establish encryption and Digital Signature (DS) over an insecure communication channel with which the participating parties are communicating.

In public key cryptography, each of the authorized parties participating is assigned a pair of cryptographic keys, a private-key and a public-key. The public key is made public, meaning that it is in the possession of all the participating parties (and may ultimately become known as well to an eavesdropper or a disrupter). However, the private key remains secret, and its knowledge must be in the possession of its owner only. Since the public key is made public, forgery of secured messages can be easily managed. This is one of the reasons for using a DS, as will be explained herein.

The channel security and efficiency of a public key cryptosystem depends on many parameters, among them: (a) the complexity of determining the private key from knowledge of the public key; (b) the complexity of the encryption/decryption processes; (c) the length of the ciphertext and the public key in comparison to the length of the plaintext.

To send a secured message, one should use the recipient public-key to encrypt the message prior to its transmission. Since all the participating parties share their public-keys, everyone may encrypt a message that is intended for other individuals, utilizing their public-keys. To reveal the transmitted information, the recipient decrypts the received message utilizing his private key. It is important to emphasize that the message can be decrypted only with the recipient's private key. This way, the message content may be revealed only by authorized recipients, assuming that the knowledge of the private key is in their possession only.

Digital signature is utilized to identify the source of the transmitted message (like a signature on a check). A DS is established utilizing a unique identifier of the message source. The said identifier is encrypted, utilizing the sender's private key. It should be mentioned that the transmitted message is not necessarily encrypted in this case. However, it is transmitted accompanied by the message's DS.

The recipient is interested to guaranty for the message source (identification) and to assure that the message content has not been tampered with (authentication). To do so, the recipient produces a message identifier, similar to the way it was produced by the sender. Then, the received DS is decrypted, utilizing the sender public key, thus revealing the message identifier that was originally produced by the sender. If the two message identifiers differ, then the received message was forged, or changed after its transmission. Since only the sender has access to his private key, it is assumed that no one can forge the DS assigned to messages sent by him.

In practice, the information to be transmitted is usually truncated into fixed size blocks called packets. When said information is sent over the Internet, for instance, it is almost always carried out utilizing different routes for the different packets. Hence, an opponent may easily replace a packet or tamper with its contents. To prevent such problems, the sender should seal every packet that he sends. Typically, each packet is sealed with a dedicated DS prior to its transmission. To detect replacement of blocks, done by opponents, the recipient must check the DSs of each of the packets received. In this way, it is guaranteed that the content of said packet is as it was originally transmitted and that the received blocks weren't changed.

In public key cryptography, the public and private keys are always linked mathematically. Therefore, it is always possible to derive the private key from knowledge of the public key. However, cryptosystems are designed such that the problem of deriving the private key from the public key is a “hard problem” (i.e., an enormous computational effort is required to derive a solution), typically, requiring factoring a large number, which is computationally an unfeasible task.

The public key cryptographic algorithm developed by Ron Rivest, Adi Shamir, and Leonard Adelman (RSA) in 1977, is very common today in encryption and DS applications. In the RSA algorithm and its variations, the cryptographic keys are derived from two large primes, p and q. Encryption and decryption are performed utilizing the result of those primes product g=p×q for its modular arithmetic computations. The public key is another number, e (e<g), that is relatively prime to (p−1)×(q−1) (i.e., they have no common factors except 1). The public key, d, is another number which satisfies that (e×d−1) is divisible by (p−1)×(q−1).

According to the modular arithmetic utilized in the RSA method, the encrypted message c is established utilizing the plaintext message s for the modular computation c=s^{e} (mod g), where e is the recipient public key. The recipient decrypts the received message c by performing a similar computation utilizing his private key d, s=c^{d} (mod g), which results in the original plaintext message s. A detailed description is given at http://www.rsasecurity.com/rsalabs/faq/3-1-1.html.

An eavesdropper may try to decrypt the plaintext from the transmitted ciphertext and/or the DS. A disrupter may try, for instance, to repeat, replace or corrupt the message during transmission. It is important to note that the ability to forge many meaningless but legally signed messages could be disastrous in the event of real-time procedures. It may take some critical time for the recipient to realize that legally signed messages are forged messages rather than noisy ones (in the case of the repeater). Furthermore, in cryptosystems such as RSA, it is easy to forge a meaningless signed message or to repeat the transmission of the same message or previously legally signed messages. The outcome of the transactions of a malicious repeater may be catastrophic, for instance, repeatedly sending a meaningful message like one saying “withdraw $10,000,000 from my account”.

The RSA cryptosystem is based on the difficulty of factorizing large integers, it is computationally infeasible to determine the private key d given the public key e. Hence the public key, e, can be made public. However, the computational effort involved in the encryption and the decryption is relatively large. In terms of asymptotic efficiency, the expected upper boundary of the RSA encryption/decryption scales to O(N²/O(N³), wherein N is the plaintext length.

At present, different tasks of the secured channel are usually performed utilizing different methods. For instance, it is very common today to use RSA to carry out the encryption/decryption tasks, while Standard Digital Signature (SDD) is a modification of the ElGamal signature scheme, as was published in the Federal Register on May 19, 1994, and adopted as a standard on Dec. 1, 1994. The reason for the plurality of methods utilized to establish a secure channel mostly stems from the computational effort those methods involved and the required level of security. Moreover, in most of the cryptographic methods used today there is no way to distinguish between the same message transmitted from different locations, and/or different time. More particularly, when a message is encrypted, utilizing a given public-key, at different times or locations, the obtained ciphertext is always the same. From this reason, repeating a transmission is a very easy task.

It was recently found that even plaintext of the length N=512 may be too small to ensure a secure channel, as was described in details in http://tirnanog.ls.fi.upm.es/Servicios/Alejandria/InfoTecnica/512b_Broken. html and in http://www.cwi.nl/˜kik/persb-UK.html. Hence, the complexity of the encryption/decryption results in the bottleneck of public-key cryptosystems as well as for other tasks of the secure channel (digital signature, authentication, etc.) based on such methods. In fact, the complexity of an RSA cryptosystem with N=1024 is estimated to scale to O(10⁹), which is a heavy task even for powerful computers, especially in real time, such as for cellular phones, or even banks, which receive many transactions a day. All these methods indicate that there is a tradeoff between the secure channel and the complexity of the encryption/decryption processes. Therefore, there is a need for reliable, secure cryptographic methods requiring less computational effort and reduced complexities.

It is an object of the present invention to provide a method and apparatus for a secure public key cryptosystem operating with low complexity, providing encryption, identification, and authentication and other possible tasks of the secured channel.

It is another object of the present invention to provide a method and apparatus for a secure public key cryptosystem in which the computational complexity is linearly scaled with the length of the plaintext, or polynomially (N^{α}, α>1) with the length of the plaintext, and in which the size of the public-key scales linearly with the size of the plaintext or polynomially with the length of the plaintext.

It is a further object of the present invention to provide a method and apparatus for a secure public key cryptosystem that is based on Boolean algebra and in which the complexity of either the encryption or the decryption scales linearly with the length of the plaintext, or slower, meaning polynomially with the length of the plaintext or slower than linear.

It is still another object of the present invention to provide a method and apparatus for a secure public key cryptosystem based on error-correcting codes and on numerous stochastic ingredients, and which, in the case of homogenous noise and/or inhomogenuous noise, provides an efficient method for solving both the problem of error correction and for the tasks of the secure channel.

It is still a further object of the invention to provide a method and apparatus for a secure public-key cryptosystem utilizing the same algorithm for all the different tasks of the secure channel.

It is still a further object of the invention to provide a method and apparatus for a secure public-key cryptosystem which enables to identify and disregard opponent attacks such as repeating, and/or replacing transmitted data blocks.

It is still a further object of the invention to provide a method and apparatus for a secure public-key cryptosystem in which the same message transmitted at different times to the same place, or at the same time to different places, may be encrypted differently.

It is still a further object of the invention to provide a method and apparatus for a secure public-key cryptosystem which is applicable to the Gaussian channel, the Binary Symmetric Channel (BSC), and other communication channels.

It is still a further object of the invention to provide a method and apparatus for a secure public key cryptosystem in which the complexity of the encryption/decryption is reduced by O(N) under parallel dynamics.

It is still a further object of the invention to provide a method and apparatus for a secure public key cryptosystem in which inhomogeneous noise may be utilized for ciphering.

It is still a further object of the invention to provide a method and apparatus for a secure public key cryptosystem, which enables the transmission to be absolutely hidden.

It is still a further object of the invention to provide a method and apparatus for a secure public key cryptosystem, which is based on error-correcting codes utilizing sparse (or dense) matrices as cryptographic keys.

It is still a further object of the invention to provide a method and apparatus for a secure public-key cryptosystem in which many different corrupted public-keys may be constructed from the same public-key.

It is still a further object of the invention to provide a method and apparatus for a secure public-key cryptosystem based on ECC which does not restrict the average connectivity of the rows or columns of the constructing matrices to be less than 2, and according to which a plurality of cryptographic keys are efficiently and easily obtained.

It is still a further object of the invention to provide a method and apparatus for a secure public-key cryptosystem based on ECC with improved security and efficient means for DS and authentication, and with enhanced immunity to noise and errors.

It is still a further object of the invention to provide a method and apparatus for a secure public-key cryptosystem based on ECC utilizing noisy plaintexts to improve security, ciphering and allow the use of dense noise, and optionally to improve data compression.

It is still a further object of the invention to provide a method and apparatus to initiate a secure channel which is based on standard cryptographic methods or ECCs utilizing a secure public-key cryptosystem based on ECC to encrypt the parameters required to initiate the communication.

It is still a further object of the invention to provide a method and apparatus for a secure public-key cryptosystem based on ECC in which the rate is enhanced to 1, and the efforts of decryption/encryption are substantially reduced.

It is still a further object of the invention to provide a method and apparatus for a secure public-key cryptosystem based on ECC to encrypt/decrypt the content of storage devices in computerized systems thereby allowing the access to the stored information only to those with access to the cryptographic key.

It is still a further object of the invention to provide a method and apparatus for a secure public-key cryptosystem based on ECC to encrypt/decrypt the parameters required to establish communication utilizing a known ECC method, thereby establishing a time dependent ECC.

It is still a further object of the invention to provide a method and apparatus for a secure public-key cryptosystem based on ECC utilized to encrypt/decrypt the parameters required to establish communication based on spread spectrum techniques, thereby enabling to hide the communication, and/or to randomly pick a spreading scheme (e.g., PN code), and/or a random spread of the communication spectrum.

It is still a further object of the invention to provide a method and apparatus for a secure public-key cryptosystem based on ECC in which new private-keys may be easily obtained, thereby enabling secure communication with time dependent key scheme to take place.

It is still a further object of the invention to provide a method and apparatus for a digital signature in which the sender is not required to publicize verification information.

It is still a further object of the invention to provide a method and apparatus for a secure public-key cryptosystem based on ECC for encryption of the operating system, in computerized systems, to prevent viruse and other malicious attacks.

It is still a further object of the invention to provide a method and apparatus for a secure public-key cryptosystem based on ECC for encrypting/decrypting the parameters required to establish communication utilizing spread spectrum techniques in a dynamic communication network wherein the spreading spectrum codes are dynamically altered to enhance channel capacity and improve security.

It is still a further object of the invention to provide a method and apparatus for a secure public-key cryptosystem based on ECC in which the coding rate is dynamic such that different blocks of the transmission are produced utilizing different cryptographic keys with different rates.

Other objects and advantages of the invention will become apparent as the description proceeds.

### SUMMARY OF THE INVENTION

The following terms are defined as follows:

x=O(N): indicates that x is proportional to N, for instance x=5N, means that x/N=constant that is independent of N.

Private noise: a noise known only to one side of the channel. The noise added to the ciphertext is a private noise of the sender. The noise added to the public key is a private noise of the recipient.

Diagonal block matrix: a matrix in which all the non-zero elements are in square sub-matrices located along its diagonal.

Noisy plaintext: a plaintext with additional noise added prior to encoding or Encryption. This noise is correlated with the noise added after the encryption, and optionally with previous data and noise

In one aspect, the invention is directed to a method for a secure public key cryptography employing a parity check error-correcting code, and noise signals, comprising:

a) creating a communication channel;

b) providing a set of private cryptographic keys which are assigned to each of the entities utilizing said secure public cryptography, wherein each of said private cryptographic keys may be accessed only by the entity it was assigned to;

c) providing a set of public cryptographic keys assigned to entities utilizing said secure public-key cryptography; and

d) providing a set of random private noise signals, or generating the same using a random private noise signal generator;

the method further comprising ciphering vectors of information by adding a noise signal to the information vector before encryption and/or after the encryption.

According to a first embodiment of the invention a fraction of the rows of the cryptographic public-key are corrupted by randomly flipping some or all of the bits in said rows, to obtain the corrupted public-key [Êₖ].

According to a second preferred embodiment of the invention a message “s” is encrypted utilizing the public key of the recipient, [Eₖ], to obtain −c=[Eₖ]s.

In a fourth preferred embodiment of the invention a message “s” is encrypted utilizing the corrupted public key of the recipient, [Êₖ], to obtain −c=[Êₖ]s.

The method may further comprise:

a) adding a private noise signal, nₐ, to the encrypted message c, to obtain the ciphertext t=c+nₐ;

b) transmitting said ciphertext t to the recipient, and upon receipt of said transmission by the recipient, decrypting said ciphertext and therefore revealing the message s and the private noise nₐ; and

c) decrypting said ciphertext t, upon receipt, utilizing decryption algorithm, thereby revealing the message “s” and the private noise signal, nₐ.

According to a fifth preferred embodiment of the invention the ciphering and the deciphering comprises:

a) providing a first vector of data s of dimensions N×1;

b) providing a private-public key for encryption, wherein said public key is the generator matrix [Eₖ] of an error-correcting code, and the dimensions of said generator matrix are M×N;

c) generating a second vector n, wherein said second vector comprising a noise signal, and the dimensions of said second vector are M×1;

d) generating a third vector n₁, of dimensions N×1, by performing permutations and bit manipulation on said second vector n, by following a known procedure;

e) generating a fourth vector of data sₙ by the Boolean addition of said first vector s with third vector n₁ to obtain sₙ=s+n₁ (mod 2);

f) generating a fifth vector C by encrypting said fourth vector sₙ utilizing said public key [Eₖ] to obtain C=[Eₖ]sₙ (mod 2);

g) generating a ciphertext vector r by adding said second vector n to said fifth vector C to obtain r=C+n (mod 2);

h) upon deciphering said ciphertext vector r:

h.1) obtaining said second vector n and said fourth vector sₙ by decrypting said sixth vector r utilizing the private key of said public key;

h.2) obtaining said third vector n₁ by employing permutations and bit manipulation to said second vector n following the same procedure used in step d); and

h.3) revealing said first vector s by subtracting said obtained fourth vector sₙ from said third vector n₁ to obtain s=sₙ−n₁.

The ciphering can be carried out, for instance, utilizing the corrupted public-key [Êₖ].

According to a sixth preferred embodiment of the invention the ciphering/deciphering consists of two layers, comprising:

a) providing a data vector v;

b) providing a set of public-keys Pub^{j} and their corresponding private-keys Pri^{j};

c) dividing said data vector v into a set of k₀ data vectors v₁, v₂, . . . , vₖ₀;

d) generating a vector n comprising a noise signal;

e) generating a vector n₂=f₂(n) following a known procedure f₂ wherein said procedure comprises permutations and bits manipulation performed to the vector n;

f) selecting an ordered set of k₂ public-keys Pub^{f′(i)} from said set of public-keys Pub^{j} utilizing an indexing scheme f′ to select the f′(i) public-key of said set of public-keys Pub^{f′(i)};

g) encrypting each of the data vectors v₁, v₂, . . . , vₖ₀ with a corresponding public-key from said ordered set of k₂ public-keys Pub^{f′(1)}, Pub^{f′(2)}, . . . ,Pub^{f′(k}^{₂}⁾ to obtain a vector s consisting of a set of encrypted vectors s={sᵢ}ᵢ₌₁^{k0}={Pub^{f′(i)}₍ᵥ_{ᵢ}₎}ᵢ₌₁^{k0};

h) encrypting the vector s as described in the fifth preferred embodiment of the invention sections a)-g), taking s as the first vector of data, and n as the second vector, to obtain the ciphertext vector r;

i) upon deciphering said ciphertext vector r:

i.1) deciphering the ciphertext vector r as described the fifth preferred embodiment of the invention sections h.1)-h.3), and thereby revealing the vector n in section h.2) and the vector s in section h.3) of the fifth preferred embodiment;

i.2) dividing the vector s into a set of k₀ vectors s₁, s₂, . . . , sₖ₀;

i.3) generating a vector n₂=f₂(n) following a known procedure f₂ where said procedure comprise permutations and bits manipulation performed to the vector n;

i.4) selecting an ordered set of k₂ private-keys Pri^{f′(i)} from said set of private-keys Pri^{j} utilizing the indexing scheme f′ to select the f′(i) private-key of said set of private-keys Pri^{f′(i)}; and

i.5) decrypting each of the data vectors s₁, s₂, . . . , sₖ₀ with a corresponding private-key from said ordered set of k₂ private-keys Pri^{f′(1)}, Pri^{f′(2)}, . . . , Pri^{f′(k}^{₂}⁾ to obtain a vector v consisting of a set of decrypted vectors v={vᵢ}ᵢ₌₁^{k0}={Pri^{f′(i)}₍ₛ_{₁}₎}ᵢ₌₁^{k0};

The set of private-keys Pri^{j} and public-keys Pub^{j} can be, for instance, RSA cryptographic keys.

In one particular embodiment of the invention the noise signal n₂ is utilized to guide the indexing scheme f′.

In a 7'th preferred embodiment of the invention the indexing scheme f′(i) is determined according to the binary number n₂ⁱ represented by the i'th block of bits n₂ⁱ=[(i−1)·Nₚ+1,i·Nₚ] of the private noise signal n₂, where the length of said block is

$${N}_{p} = \frac{N}{{k}_{0}} ,$$

and the index of the cryptographic key is obtained from the computation of mod(n₂ⁱ,k₂).

The indexing scheme f′(i) can alternatively be determined according to the binary number n₂ⁱ represented by the i'th block of bits n₂ⁱ=[(i−1)·k₂+1,i·k₂] of the private noise signal n₂, and wherein the index of the cryptographic key is obtained from the rounding of the computation of log₂(n₂ⁱ).

The ciphering and deciphering can be utilized to configure a turbo error correcting code.

According to a further preferred embodiment of the invention the ciphering and deciphering are- utilized to configure other types of cryptosystems or types of error correcting codes, comprising:

a) ciphering the parameters and other data required to configure communication. utilizing a known error correcting code or cryptographic method, said ciphering being performed as described in any one of the preferred embodiments of the invention;

b) transmitting said ciphered parameters and other data to another participating party;

c) decrypting said ciphered parameters and data information upon receipt, to reveal said parameters and other data; and

d) initiating communications by configuring a known method according to said parameters and other data.

Another preferred embodiment of the invention relates to a method wherein the public-key [Eₖ] and the private-key are uniquely derived utilizing two sparse matrices [A] and [B], comprising:

a) providing a first sparse and Boolean matrix [A] of dimensions M×N;

b) providing a second sparse and Boolean matrix [B] which is invertible and of dimensions M×M;

c) deriving the cryptographic public-key, [Eₖ], from the matrix multiplication result [Eₖ]=[B]⁻¹[A]; and

d) constructing the cryptographic private-key, [Dₖ], from said pair of sparse matrices, [A] and [B], to obtain [Dₖ]=[A,B].

The second sparse and Boolean matrix [B] can be, e.g., a diagonal matrix comprising a set of k=O(N) square and Boolean sub-matrices wherein each of said sub-matrices is invertible, and the non-zero elements in the sparse matrices, [A] and [B], can be randomly located within each of the sparse rows. Preferably, but not limitatively, the average connectivity of rows and/or columns of the second sparse and Boolean matrix [B] are equal or greater than 2. Still preferably and non-limitatively, the second Boolean matrix [B] is a diagonal matrix comprising a set of k=O(N^{α}) (α<1) square and Boolean sub-matrices wherein each of said sub-matrices is invertible. The method can be used for producing a set of different public keys by performing permutations of the rows/columns of the sparse matrix [B] and/or matrix [B]⁻¹. Optionally, [B]⁻¹, the inverse of the sparse matrix [B] is also sparse. Still optionally, the derived public-key, [Eₖ]=[B]⁻¹[A], is also sparse. In a preferred embodiment of the invention the average connectivity of the derived public-key, [Eₖ], is less than 2.

The aforementioned method may further comprise the construction of sparse matrices [A] and [B] comprising:

a) constructing matrix [A] from groups of sparse rows where the number of non-zero elements in the rows belonging to a specific group of said groups is fixed and predefined; and

b) constructing matrix [B] from linear-independent sparse rows where each of said rows belongs to a group of sparse rows, and where the number of non-zero elements in the rows belonging to a specific group of said groups, is fixed and predefined.

According to a preferred embodiment of the invention the method further comprises performing permutations in the order of the sparse matrices rows, [A] and [B], where said permutations may be performed arbitrarily to obtain new sparse matrices.

In another aspect the invention relates to a method which further comprises constructing a time dependent cryptographic key scheme wherein the time dependent components of each transmission, the private noise signal and/or the transmitted information, are utilized to choose the cryptographic key of the next transmission. According to a preferred embodiment of the invention the same noise signal is utilized for ciphering a set of data blocks.

Thus, in a method according to a preferred embodiment of the invention, the ciphering and deciphering comprises:

a) providing a vector of data;

b) dividing said vector of data into an ordered set of blocks of the same length;

c) ciphering the first block of said ordered set of blocks utilizing a noise signal and a public-key, as described above;

d) ciphering all other blocks of said ordered set of blocks, apart from said first block, by adding said noise signal to each of said other blocks, thereby obtaining a set of ciphered blocks from said set of ordered blocks;

e) upon deciphering said set ciphered blocks:

e.1) deciphering the first block of said set of ciphered blocks utilizing the private-key, thereby revealing the content of said first block, and said noise signal; and

e.2) deciphering all the other ciphered blocks of said set of ciphered blocks, apart from said first block, by subtracting said noise signal from each of said other ciphered blocks.

According to another preferred embodiment of the invention the ciphering and deciphering comprises:

a) providing a vector of data;

b) dividing said vector of data into an ordered set of blocks of the same length;

c) ciphering the first block of said ordered set of blocks utilizing a noise signal and a public-key, as described above;

d) ciphering all other blocks of said ordered set of blocks, apart from said first block, by the following steps:

d.1) encrypting each block by performing vector and matrix multiplication of the each block by an invertible matrix [E₁];

d.2) adding said noise signal to each of said encrypted blocks, thereby obtaining a set of ciphered blocks from said set of ordered blocks;

e) upon deciphering said set ciphered blocks:

e.1) deciphering the first block of said set of ciphered blocks utilizing the private-key, thereby revealing the content of said first block, and said noise signal; and

e.2) deciphering all the other ciphered blocks of said set of ciphered blocks, apart from said first block, by subtracting said noise signal from each of said other ciphered blocks; and

e.3) performing vector and matrix multiplication of the signal obtained in e.2) by the inverse matrix [E₁]⁻¹.

According to yet another preferred embodiment of the invention the ciphering rate is enhanced to one.

According to a preferred embodiment of the invention the ciphering and deciphering can be utilized to conceal the information stored on a storage device to allow the access to the information stored on said storage device only to entities having access to the concealing cryptographic key. The cryptographic key can be stored on disk or other type of magnetic or optic storage media that may be accessed via a computerized system. Furthermore, the cryptographic key can be split among a set of computer systems, connected in a network, where only a predefined number of computer systems from said set of computer systems is required in order to reconstruct said cryptographic key.

In another aspect of the invention, encryption and ciphering are utilized to improve data compression of the transmitted information by the use of private noise signals to make changes in the statistical features of the transmission, and therefore enabling better compression of the data.

The noise signal(s) of the first block(s) can be utilized for random selection of the communication and/or ECC parameters required for initiating communication between subscribers in a cellular communication networks in which the transmitted data is concealed from any arbitrating devices in the network.

Furthermore, encryption and ciphering can be utilized to construct a communication channel utilizing time dependent ECC, or spread spectrum techniques, comprising a scheme according to which the parameters to establish said ECC or said spread spectrum code are transmitted with the first block(s), or selected in accordance with the content of the private noise signal of the previous transmission(s), thereby establishing a dynamic spread spectrum scheme or ECC encoding/decoding.

The coding rate can be continuously changed, according to a preferred embodiment of the invention, by utilizing a set of cryptographic keys, and choosing a different key for each transmission. In one embodiment the private noise of previous transmission is utilized to select the cryptographic key utilized for the encryption/decryption of the next transmission(s). The noise signal can be obtained from a fixed set, or where said noise signal is time dependent and obtained by some manipulation performed to the content the -disc or another computer device, or alternatively, where said noise signal depends on the environment, or was directly typed by the user.

In another aspect the invention relates to a secure channel system which is a public-key cryptosystem.

According to a preferred embodiment, the secure channel system of the invention is a digital signature system.

The invention further provides for the hiding of the transmission utilizing Spread Spectrum techniques comprising:

a) utilizing the recipient public-key to send a ciphered message comprising the Spread Spectrum parameters that will be utilized for the transmission of the message;

b) receiving said message, deciphering said message, and revealing said Spread Spectrum parameters;

c) sending a message utilizing Spread Spectrum techniques modulated with accordance to said parameters; and

d) receiving said message and utilizing said parameters to demodulate the received Spread Signal;

According to a preferred embodiment of the invention the parity check error-correcting code is of the Gallagar type, or any version of it like MN-code.

According to a preferred embodiment of the invention a convolution code is utilized for the encryption process. Preferably, but not limitatively, the number of operations required to perform encryption and decryption is linearly scaled to the length of the message “s”. Still preferably and not limitatively, the noise signal is of fixed flip rate, or where each of the bits of said noise is of different flip in a manner known both to the sender and the recipient.

According to a preferred embodiment of the invention the encryption comprises successive encryption of a message [C₀]_{N×1}=s utilizing a predetermined set of Q public-keys └Eₖ_{ⱼ}┘_{M}_{ⱼ}_{×M}_{ⱼ₋₁} (1≦j≦Q) to recursively obtain the encrypted message C_{Q} as follows −└Eₖ_{ⱼ}┘_{M}_{ⱼ}_{×M}_{ⱼ₋₁}└Cⱼ₋₁┘_{M}_{ⱼ₋₁}_{×1}=└Cⱼ┘_{M}_{ⱼ}_{×1} (1≦j≦Q), which recursively decrypted by the recipient to reveal the message C_{Q} utilizing the decryption algorithm and where said decryption algorithm is performed Q time guided by said predetermined set of Q public-keys └Eₖ_{ⱼ}┘_{M}_{ⱼ}_{×M}_{ⱼ₋₁} (1≦j≦Q).

In another aspect the invention relates to a method for constructing a digital signature for the ciphertext t of the message “s”, comprising:

a) producing a unique identifier, X(s,nₐ), where said identifier is the combination of modifications made to the message “s” and the noise signal nₐ that was utilized for the ciphering of said message s;

b) encrypting said identifier X with the corrupted public key [Êₖ] to obtain the encrypted identifier c₁=[Êₖ]X;

c) producing a digital signature from a combination of another noise signal nₐ₁ and the encrypted identifier t₁ to obtain the digital signature t₁=c₁+nₐ₁;

d) publicizing a verification vector V constructed from a combination of said message “s” and noise signals, nₐ and nₐ₁;

e) verifying the transmission source and its integrity by the following steps:

e.1) decrypting the received ciphertext t and the digital signature t₁ utilizing decryption algorithm and obtaining the decrypted message s′, and the decrypted private noise signals nₐ′ and nₐ₁′;

e.2) constructing a verification vector V′ following a predetermined procedure;

e.3) comparing verification vectors V′ and V; and

e.4) assuring transmission integrity and source identity when said verification are found to be identical or slightly different.

The invention is further directed to a method for constructing a digital signature for the ciphertext t of the message “s”, comprising:

a) producing a unique identifier, Vₛ(s,nₐ), from a combination of modifications made to the message “s” and the noise signal that was utilized for the ciphering of said message s, nₐ;

b) permuting some of the rows of the recipient public key following a permutation procedure to obtain a permuted public key [Êₖ^{P}];

c) encrypting said identifier, Vₛ, with the permuted public key [Êₖ^{P}], to obtain an encrypted signature t₁=[Êₖ^{P}]Vₛ; and

d) publicizing said permutation procedure.

e) verifying the transmission source and its integrity by the following steps:

e.1) decrypting the received ciphertext t utilizing decryption algorithm and obtaining the decrypted message s′, and the decrypted private noise nₐ′;

e.2) reconstructing the permuted public-mey [Êₖ^{P}] following a predetermined or publicized procedure;

e.3) constructing an identifier Vₛ′=f(s′,nₐ′) following a predetermined (or publicized) procedure;

e.4) encrypting said identifier Vₛ′, with the permuted public key [Êₖ^{P}] to obtain its digital signature t₁′=[Êₖ^{P}]Vₛ′;

e.5) comparing the sender's digital signature, t₁, and the digital signature of the received ciphertext t₁′; and

e.6) assuring transmission integrity and source identity when the identifiers t₁ and t₁′ are found to be identical or slightly different.

The invention also encompasses a method for constructing a digital signature for the ciphertext t of the message “s”, comprising:

a) producing a unique identifier V of the same dimensions of the message “s”, where said identifier is the combination of modifications made to the message “s” and the noise signal nₐ;

b) encrypting the identifier V with the public-key to obtain the digital signature [Êₖ]V; and

c) publicizing the procedure by which said digital signature was established.

d) verifying the transmission source and its integrity by the following steps:

d.1) decrypting the received ciphertext t and said digital signature utilizing decryption algorithm and obtaining the message s′, the private noise nₐ′, and said identifier V;

d.2) producing a new identifier V′ utilizing the decrypted message s′, and decrypted noise signal nₐ′, and by following same procedure utilized for the production of V; and

d.3) assuring transmission integrity and source identity when the identifiers V and V′ are found to be identical or slightly different.

The identifier can be constructed, for instance, from a combination of modifications made to the message “s” and the noise signal nₐ comprising flipping non-zero elements of said identifier until a predetermined number K (or less than or equal to a constant K) of non-zero elements is obtained, thereby obtaining a new identifier Vₙ;

According to another preferred embodiment of the invention the modifications comprise permutations and/or truncations and/or pasting predefined sections of the message “s” and/or the noise signal nₐ into predefined locations in each other. The permutation procedure, according to a preferred embodiment of the invention, is one in which the public-key rows are permuted, is derived from the location of non-zero elements in the message “s” or/and the noise signal nₐ content or by another procedure guided by the structure of “s” and/or nₐ.

According to another preferred embodiment of the invention the permutation procedure, according to which the public-key rows are permuted, is predefined and known to both the recipient and the sender, and therefore not required to be publicized.

### BRIEF DESCRIPTION OF THE DRAWINGS

In the drawings:

FIG. 1 formally illustrates a method to construct sparse matrices.

FIG. 2 schematically illustrating a method for a secure public-key cryptosystem according to a preferred embodiment of the invention;

FIG. 3 is a flow chart illustrating a preferred embodiment of the invention for encryption;

FIG. 4 formally illustrates the different components of the resulting ciphertext in a possible embodiment of the invention.

FIG. 5 is a flow chart illustrating a preferred embodiment of the invention for a simple digital signature; and

FIG. 6 is a flow chart illustrating a preferred embodiment of the invention for an advanced secure digital signature.

FIG. 7 schematically illustrates a method of constructing a class of sparse matrix [B];

FIG. 8 is a flow chart illustrating the encryption/decryption process according to a preferred embodiment of the invention; and

FIG. 9 is a flow chart illustrating the encryption/decryption process according to another embodiment of the invention.

FIG. 10 is a flow chart illustrating a digital signature procedure according to a preferred embodiment of the invention.

### DETAILED DESCRIPTION OF PREFERRED EMBODIMENTS

The goal of cryptography is to enable two people to communicate over an insecure channel in such a way that a potential interceptor cannot decrypt the transmitted message. In a general scenario, the plaintext (the message), s, is encrypted by the sender prior to its transmission, utilizing the recipient public key Eₖ. The resulting ciphertext, c, is sent to its destination over the channel. A third party, eavesdropping on the channel, cannot determine the content of the plaintext. However, the recipient, who knows the decryption key, can decrypt the ciphertext using his private key Dₖ and recover the plaintext.

The cryptosystem disclosed herein is based on an Error Correcting Code (ECC) method and exemplified by the Gallager-type MN code. More precisely, it is based on linear codes that are based on sparse matrices. The code is comprised from two sparse Boolean matrices, [A] which is of dimension M×N, and [B] which is a quadratic non-singular matrix of dimension M×M, and the coding rate R≡N/M<=1. By saying that the code matrices, [A] and [B], are sparse, it is meant that the number of non-zero elements, in each of said matrices, scales linearly with N. However sparse matrices according to the invention method obeys a much stronger constraint. Each line or row of a sparse matrix, according to the method of the invention, contains a finite number of non-zero elements. This is important for parallel dynamics as well as for the time delay. It is important to note that all the operations that are involved in encryption, and almost all operation in the decryption utilizing the method of the invention, are performed utilizing modular arithmetic (mod 2).

According to the present invention the cryptosystems' public key, Eₖ (which its' dimensions are M×N), is derived from the matrix product given by −[Eₖ]=[B]⁻¹[A]_{(mod 2)}. The cryptographic keys are utilized in a very similar way as in ECCs for encoding, and decoding. In this fashion, the plaintext s (which its' dimensions are N×1) is encrypted by a simple encoding operation c=[Eₖ]s_{(mod 2)}. The private key, Dₖ, is comprised from a pair of sparse matrices Dₖ=[A,B], and as will be explained hereafter, a noise signal nₐ, is added to the ciphertext, such that the transmitted and the received ciphertext, r, actually becomes r=c+nₐ=[Eₖ]s+n_{a (mod 2)}. In those methods, representing a special case of parity-check codes, each bit of the ciphertext c is derived from the parity of certain bits following the public-key matrix [Eₖ].

In the usual scenario of ECC, noise is added to the transmission by the channel. In the case of the Binary Symmetric Channel (BSC), the noise interference will cause part of the transmission bits to flip. The average fraction of flipped bits is utilized to express the flipping rate, f (0≦f≦1), of said channel. In other communication channels, such as the Gaussian channel, instead of binary bits, symbols are transmitted, and the addition of noise signals (i.e., Gaussian) in such cases results in the receipt of real numbers, which makes it more difficult to recover. According to the method of the invention, noise is added to a selected part of the ciphertext (or to the entire ciphertext) by the sender/receiver. The invention is applicable to the BSC and other channels such as the Gaussian channel as described in “Elements of Information Theory”, by T. M Cover and J. A. Thomas, (Wiley 1991).

To decrypt the received ciphertext r, the recipient utilizes [B], in attempt to reveal the plaintext message from the calculation of z=[B]r=[B](c+nₐ)=[A]s+[B]n_{a (mod 2)}. To reveal the plaintext s, it is required to find a solution for s and for the noise signal nₐ. This may be carried out utilizing s and n statistics (for instance, unbiased message for s and probability f, for nₐ), and utilizing standard methods, such as belief network decoding (also referred to as belief algorithm herein) described in “Graphical Models for Machine Learning and Digital Communication” by B. J. Frey, (MIT, Cambridge, Mass. 1998). It should be clear that other standard methods, like belief revision, might be also adequate for decryption.

It is important to note that for an average connectivity (number of non-zero elements per column) greater than 2, [B]⁻¹ is heavily dense, and the number of non-zero elements in [Eₖ], is around M·N/2. However, as long as the average connectivity of [B] is smaller than 2 and the position of the non-zero elements are chosen at random without a spatial structure, [B]⁻¹ is sparse. Since [A] is a sparse matrix it is clear that [Eₖ] is also sparse. The complexity of the decryption process also scales linearly with the size of the plaintext, as the number of iterations is of O(1). It is important to understand that a sparse public-key is a necessary requisite for an efficient encryption process of large plaintexts.

In this fashion, the complexity of the encryption/decryption processes scale linearly with the size of the plaintext N. Those complexities can be easily reduced even further under parallel dynamics where the decryption by the belief algorithm, for example, is carried out in parallel for each non-zero element in the matrices [A] and [B]. The invention's method is based on boolean operations between two sparse matrices, and as will be described later, it consists of many stochastic ingredients. Moreover, the method is applicable as a public-key cryptosystem, as well as for DSs, authentication, and other tasks of the secured channel.

For a given rate R and large N, the maximal noise probability f (for which the decryption could terminate successfully without error bits in the decrypted plaintext) is given by the maximal channel capacity C(f)=1−H₂(f) where H₂(f) is the binary entropy function given by—

H₂(f)=f·log₂(1/f)+(1−f)·log₂(1/(1−f)).

It is important to note that with the lack of noise and invertible [Eₖ] the transmission may be easily recovered by the following calculation s=[Eₖ]^{-1·}r. To complicate the task of decomposing [Eₖ] to [B] and [A] (i.e., to break the code), a fraction of the rows of the public key are corrupted. More, precisely, in a fraction p_{q} of the rows of the public key, part (or all) of the elements are flipped at random. Hence, a fraction p_{q} of the ciphertext is corrupted with an average probability ½. This is enough to enhance the difficulty of deriving [Eₖ] and still assure full recovery of the code from the corrupting noise, as explained below.

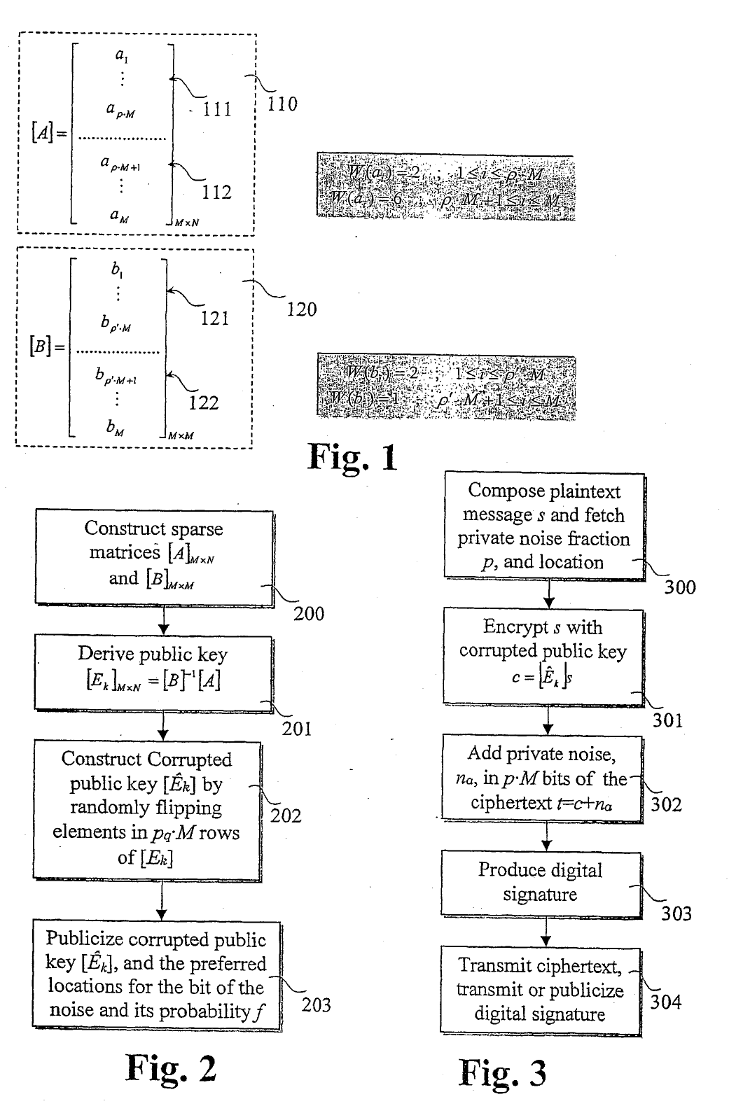

One possible method of constructing the sparse matrices, [A] and [B], is illustrated in FIG. 1. The rows of matrix [A], 110, are denoted by aᵢ, wherein i stands for the row number (1≦i≦M). Similarly, the rows of matrix [B], 120, are denoted by bᵢ. To exemplify the number of non-zero elements in a matrix row, the notion Hamming weight, W(v), is utilized. The weight of the binary vector v, W(v), is actually the number of the non-zero element in v. A fraction, ρ, of matrix [A] rows, a_{i (1≦i≦ρ·M)} 111, has 2 non-zero elements, W(aᵢ)=2_{(1≦i≦ρ·M)}. The other (1−ρ)·M rows, 112, of matrix [A], has 6 non-zero elements, W(aᵢ)=6_{(ρ·M+1≦i≦M)}. Similarly, a fraction, ρ′, of matrix [B] rows, b_{i(1≦i≦ρ′·M)} 121, has 2 non-zero elements, W(bᵢ)=2_{(1≦i≦ρ′·M)}, while the other (1−ρ′)·M rows, 122, of matrix [B] has only 1 non-zero element, W(bᵢ)=1_{(ρ′·M+1≦i≦M)}.

The non-zero elements in matrices [A] 110, and [B] 120, can be located randomly (It is found that fluctuations in the quality of the decoding process are suppressed by keeping the number of non-zero elements per column as homogenous as possible. However, it is not a condition necessary for the success of the method of the invention). However, when constructing matrix [B] rows, the non-zero element's location should be considered more carefully to obtain rows, which are linearly independent. This is because matrix [B] should be invertible, to carry out the public-key computation [Eₖ]=[B]⁻¹[A].

It should be noted that other methods to construct sparse matrices (such as in error-correcting codes of the Gaussian channel with R=½) are also adequate, and the above method is disclosed only for purposes of illustration. Additionally, it should be noted that the matrices [A] and [B] in FIG. 1 consist of only two kind of rows. In the general case, one can use matrices with many different kinds of rows (such scenarios were checked by simulations). Additionally, other rates than R=½ adequate for implementing the method of the invention.

The spatial separation between different rows of the matrices [A] and [B] in FIG. 1 (some consecutive rows with the same number of non-zero elements) is given here for demonstration only. It should be understood that one can mix the location of rows with different numbers of non-zero elements (proportional to N! factorial), thus making it more difficult to break the code, even when there is a prior knowledge regarding the connectivity, for example, of the matrices, and therefore increasing the security of the channel. However, if switching the places of some rows in [A], the same rows in [B] should also be replaced.

It should be noted that the method of the invention is not limited to any particular communication channel, and can be used in conjunction with any type of communication and environment, e.g., over the Internet, satellite communication, wireless communication, by modem communication, etc.

FIG. 2 is a flow chart illustrating the steps required to establish a secure public-key cryptosystem according to the invention. At first, step 200, two sparse matrices are constructed, matrix [A], which its' dimensions are M×N, and matrix [B], which its' dimensions are M×M. In the next step, 201, the public key, [Eₖ], is derived from the pair of sparse matrices [A], and [B]. Utilizing sparse matrices, such as those illustrated in FIG. 1, to obtain the public key, results in a new matrix, [Eₖ], which is also sparse since [B]⁻¹ is sparse. In step 202, the public-key [Eₖ] is corrupted (prior to the publication of the public key) by randomly flipping elements in a fraction, p_{q}, of the public-key rows, to obtain the corrupted version of the public key, [Êₖ] (this is an optional step).

The corrupted public key, [Êₖ], is now utilized to perform all the operations required for encryption. It is important to comment that the public key is corrupted such that the code can still recover from the errors that occur due to the public-key corruption (the bound on the number of corrupted rows is given in the equation below). In addition, one can easily construct many corrupted public-keys related to the same original one. In this case, the public-key [Eₖ] is corrupted differently to yield different public-keys, [Êₖᵢ] i=0,1,2 . . . , while still using the same private key [Eₖ]. For the opponent, or different users of the secure channel, it seems that the method has changed, where indeed it is only an illusion. Additionally, to make the method of the invention more secure, one can add dummy rows, which are later excluded during the decryption process.

Finally, in step 203, the corrupted public key is publicized accompanied by the preferred locations for the addition of the noise bits nₐ, and the noise's flip rate f. The stochastic noise nₐ, is exemplified by an homogenous noise, meaning each bit in the allowed regime is flipped with the same flip rate, f. But it should be clear that in the general scenario, bits can be flipped with probabilities depending on their index. More particularly, in such cases, the bits of the noise signal, nₐ, have different flip rates, fⱼ(1≦j≦p·M). This will make breaking the code even more difficult.

The process of transmitting information over the secure public-key cryptosystem according to the method of the invention is illustrated in FIG. 3 in the form of a flow chart. The process is initiated by composing the message s, and fetching the private noise fraction, p, and its location in the ciphertext, as publicized by the recipient. After composing the message s, the message is encrypted, in step 301, utilizing the corrupted version, [Êₖ], of the public key. The process proceeds in step 302, wherein the sender adds his private noise, nₐ, to fraction p·M of the ciphertext. It should be understood that the private noise signal statistics are such that full recovery of the code, from the errors that were comprised in it deliberately, is guaranteed, as described here below.

In step 303 a Digital Signature (DS) is produced, the DS is attached to the ciphertext, or left publicized by the sender, and it is utilized later by the recipient for source identification. According to the present invention, the DS is determined uniquely utilizing the plaintext message s, and/or the private noise nₐ, as will be explained hereafter. The process is terminated in step 304, in which the ciphertext t is transmitted, and the DS is transmitted or left publicized to the recipient. It should be understood that the encrypted message may be transmitted without DS, so that step 303 is optional.

Matrix [B], 120, construction, as illustrated in FIG. 1, provides a sparse matrix with average column density (the number of non-zero elements in a column) which is less than 2. As such, the inverse matrix, [B]⁻¹, is also sparse, and therefore the resulting public-key obtained in step 201, is also sparse. For large N, the encryption evolves a product of a sparse matrix [Êₖ]_{M×N} by the plaintext s, hence its complexity scales to O(N). Similarly, the complexity of each step of the decryption is O(N). Clearly, this complexity is less than the cubic complexity of the decryption process in the RSA cryptosystem.

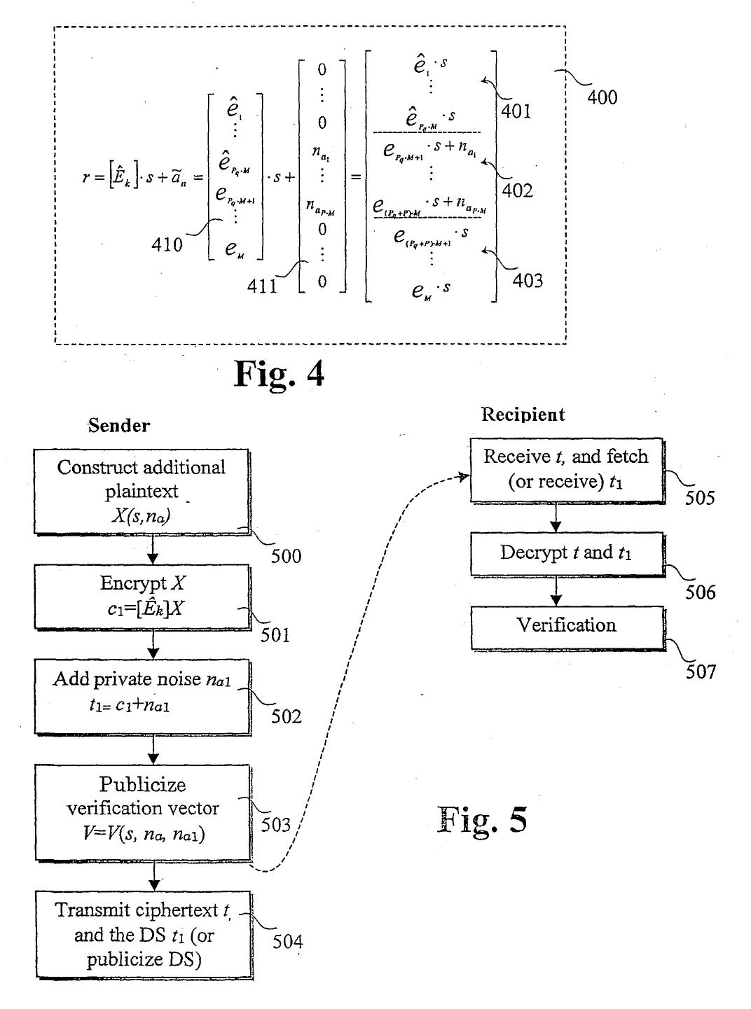

The recipient publicizes a given fraction, p, of the ciphertext where the sender private-noise, nₐ, can be added. This localized private-noise consists of a flip rate f of given p·M bits of the ciphertext. FIG. 4 formally illustrates one possible process, 400, of constructing the ciphertext, and private-noise addition, according to the method of the present invention. In FIG. 4, the rows of the public-key, 410, are denoted by eᵢ(1≦i≦M. The private-noise vector 411, is a binary vector comprising (1−p)·M zero elements, while the rest of the p·M elements comprise the private-noise signal nₐ. Also in FIG. 4, the corrupted rows of the public-key, are denoted by êᵢ(1≦i≦p_{q}·M). It should be noted that in general, the corrupted rows of the public key can be the same or have an overlap with the noisy bits.

The resulting ciphertext is then comprised from frozen (non-flipped) bits 403, eᵢ·s((p_{q}+p)·M+1≦i≦M), randomly flipped bits 401, êᵢ·s(1≦i≦p_{q}·M), and flipped bits with probability f 402, eᵢ·s+nₐᵢ(p_{q}·M+1≦i≦(p_{q}+p)·M. The presence of flipped bits in the plaintext serves to increase the secure channel and the presence of frozen bits serve to suppress finite size effects. Similar to Shannon's bound, one can show that for a given rate R the maximal fraction of flipped bits with probability f is—

$${p}_{e} = \frac{1 - {p}_{q} - R}{{H}_{2} ( f )} .$$

As was mentioned before, the flip rate of the noise signal, nₐⱼ(1≦j≦p·M), can be varied from bit to bit and may depend on the bit index j, so that for each noise bit, nₐⱼ, there is a corresponding flip rate, fⱼ(1≦j≦p·M). In this case, the sender follows a predetermined pattern of flip rates fⱼ, or alternatively, utilizes random patterns and publicizes them. The recipient will utilize said flip pattern to guide the belief algorithm when the decryption is performed, and therefore should have access to this information. It should be noted that in order to increase the security, the preferred number of not perturb bits, 403, in the ciphertext, should be less than N.

We assume that a fraction p_{q} of the bits are flipped with probability ½. The maximal fraction, p_{c}, of flipped bits with probability f, might even be further improved for the following reason. In an error-correction scenario only statistical properties of the plaintext and the flip rate are known, hence any decoded state obeying these statistical features is valid. In contrast, the recipient knows the manner in which [Eₖ] was corrupted and hence the error in the p_{q}·M corrupted bits should be consistent with the decrypted plaintext.

For instance, in the following examples the decryption terminates successfully (ρ and ρ′ denotes the fraction of the rows, in [A] and [B] respectively, in which the Hamming weight is 2, as illustrated in FIG. 1): (a) ρ=⅞, ρ′=½ and (N,p,p_{q},f)=(512,0.53,0−0.04,0.04), (b) ρ=ρ′=¾ and (N,p,p_{q},f)=(1024,0.53,0−0.04,0.075) and (c) ρ=⅞, ρ′=¾ and (N,p,p_{q},f)=(768,0.53,0−0.04,0.088). In all these examples, the decryption terminates successfully over at least 10⁵ plaintexts in a finite fraction of the chosen realizations.

These results indicate that the probability for a wrongly decrypted block (plaintext) is P_{B}<10⁻⁵. The number of iterations of the belief algorithm is typically 10 steps, in all the above-mentioned classes, where the complexity of each step of the algorithm is of the order of the number of non-zero elements in matrices [A] and [B], O(N). No long tail in the distribution of the convergence time was observed. Note that each of the belief algorithm iterations can be implemented in parallel over the non-zero elements of the matrices [A] and [B] such that the time complexity can be reduced to O(1). The results indicate that finite size effects are efficiently suppressed by the frozen bits 403 (in contrast to homogeneous noise), this can be even further improved by increasing size of the plaintext N. Moreover, it is known that reducing loops in the structure of [A] and [B] improves the results of the decoding (A loop is formed when following a route directed by the locations of non-zero elements in matrix rows, such that the location of the non-zero element within a row directs the route to the next row, if such route is reaching some point which is within the route already a loop is created. For instance if the x element in row y is a non-zero element and in row x there is a non-zero element located in the y location, a loop is formed.)

In a possible attack, assuming that there are (1−p)·M rows in [Êₖ] that are linearly independent (which comprise the rows of the public key that corresponds to the (1−p)·M correct bits, 401 and 403, of the ciphertext), the eavesdropper's task will be now to correctly guess additional N−(1−p)·M=N·(R+p−1)/R rows in order to construct a plausible invertible matrix (of dimension N×N). The probability of such an event is (1−f)^{N-M·(1-p)} and it becomes negligible as we increase the size of our plaintext (i.e. N). Furthermore, in simulations it was realized that the (1−p)·M correct rows are not linearly independent, hence the eavesdropper has to guess now additional correct rows of the public-key and the probability of such an event decreases even further.

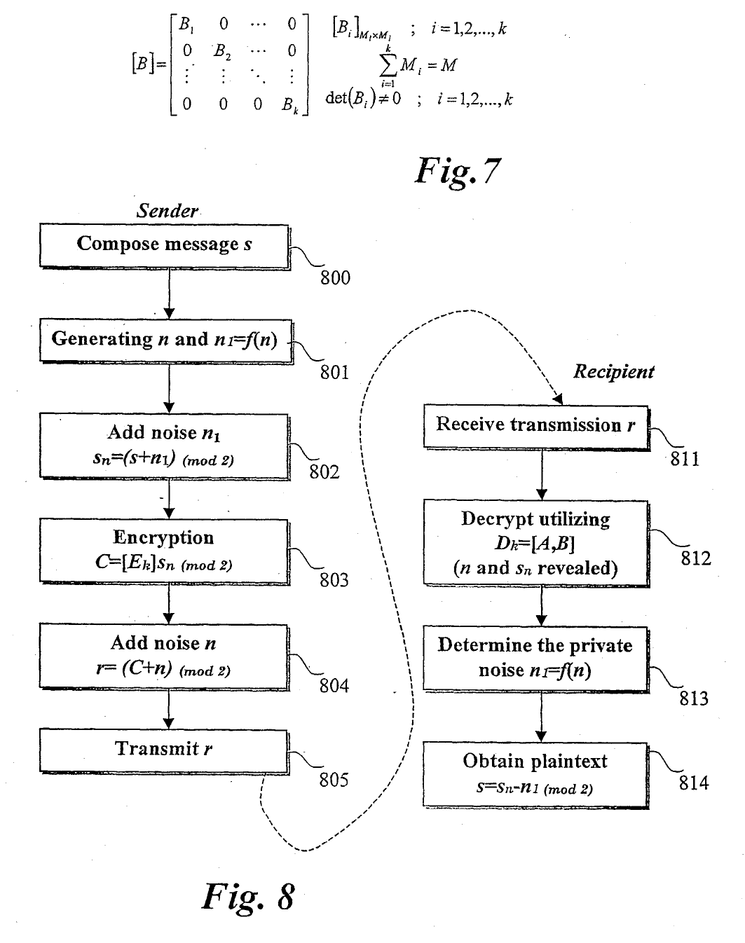

One may follow a different scheme to build a linear and secure cryptosystem using the above-mentioned error correction codes. FIG. 7 formally describes construction of matrix [B] according to another embodiment of the invention. The matrix [B] is constructed from k square sub-matrices [Bᵢ]₍ᵢ₌1,2, . . . ,k) along the diagonal of [B] (i.e., [B]=diag([B₁],[B₂], . . . ,[Bₖ])). Each sub-matrix [Bᵢ] is of dimensions Mᵢ×Mᵢ

$${}_{( i = 1 , 2 , … , k )} , such that {\sum }_{i = 1}^{k} {M}_{i} = {M}_{i} = M .$$

In addition, to yield an invertible matrix [B], each sub-matrix [Bᵢ] should be invertible (det(Bi)≠0). To assure that [B] is also sparse, one simply constructs k=O(N) sub-matrices [Bᵢ] wherein the dimension of each of them is Mᵢ=O(1). The number of non-zero elements in each row is bounded by the rank of the matrix only.

This also guaranties obtaining a sparse public-key [Eₖ], and there is no necessity to restrict the connectivity of [B] to be less than two, since the connectivity of each block sub-matrix [Bᵢ] may be varied in the range [1,Mᵢ] (as long as it is invertible).

Although the space of plausible matrices [B] is substantially reduced by the construction of sparse matrices [B] as was described here above. However, the scaling of the number of possible matrices still scales (at least) exponentially with M and therefore does not alter the security of the cryptosystem.

The number of plausible matrices [B] may be reviewed as similar to the problem of how many ways an integer M can be partitioned into different sequences of integers (different orders of the same set of integers have to be taken into account). Moreover, it is possible to construct different invertible sub-matrices [Bᵢ], of given dimensions Mᵢ×Mᵢ, by permutations of rows/columns within [Bᵢ]. More plausible sparse and invertible [B] matrices may be produced by the permutation of the appropriate rows/columns in [B]/[B]⁻¹, to obtain a new matrix, which its structure is not from the pure sub-matrices blocks along the diagonal.

All of the above-mentioned complexities contributes an extensive entropy to the available space of [B]. It should be noted that the percolation of information among all binary elements representing the noise and the source message in the encoding/decoding processes is established via the matrix [A]. It should also be noted that the above sub-matrices may be used as one of the modular ways to construct a manifold of invertible matrices with given properties. This feature is of great importance in applications where it is preferred to generate an invertible matrix in the first attempt without checking that the matrix is invertible, which is a heavy computational task.

A possible attack on such cryptosystems is one which utilizes a partial public key [E^{k}ₚₐᵣₜ], of dimensions N′×N, since we choose rows but the number of columns is fixed by N, which is invertible, and in which the corresponding N′ bits of the ciphertext are the correct ones (N′≧N). In such a case the plaintext s may be easily decoded.

The key point of the invention's signature scheme is that after the decryption process terminates successfully the recipient recovers not only the plaintext s but also the private noise, nₐ. More precisely, from the decryption of the ciphertext t, the recipient determines the original plaintext by using the corrupted public-key, [Êₖ]. On the other hand, the recipient has the received ciphertext, t=[Êₖ]s+nₐ. From the difference between these two pieces of information, the private noise nₐ can be easily found. As will be discussed hereafter, the ability to reveal the private noise, nₐ, is used to sign and to keep the integrity of the message.

In practice, the method of the invention works well also in cases wherein the signal, nₐ, is not fully decoded in the decryption process. Since this point may be crucial for applications, it should be understood that even when few plausible noise signals are found to be appropriate for the same plaintext according to the Belief algorithm decoding (especially close to saturation, i.e. near Shannon's bound), all these possible noise signals are highly correlated, and hence if the combination of the noise and the palintext in the signature is satisfied for high percentage of the bits (e.g., 93%). It is also a criterion which is far from a random guess. The security of the channel does not alter and it remains the same in the leading order.

FIG. 5 is a flow chart illustrating the process of producing a simple DS. The process is initiated in step 500, where an additional plaintext, X(s,nₐ), is constructed from a linear combination of the message s and/or nₐ. For example, such linear combinations of s and nₐ may comprise modulus 2 addition of a modification of the signals, s and nₐ, which may involve Boolean bit operations such as inverting fraction of the bits, and/or permutations (such as bit rotation). In general, the length of said additional information, X(s,nₐ), may be different from the plaintext's length (by performing truncations, or by pasting fractions of the vectors, e.g., adding a fraction of s into nₐ).

In the next step, 501, the new plaintext X is encrypted to a new ciphertext, cₐ, utilizing [Êₖ]. In step 502 a new private noise nₐ₁, is added to the new ciphertext c₁ to produce a corrupted version, t₁, of the new plaintext X.

Next, in step 503, a verification vector, V, is publicized. The verification vector is constructed by following a known procedure also involving some linear combination comprising Boolean bit operations, and/or permutations of the message s and the noise signals, nₐ₁ and nₐ.

The verification vector, V, is made public, and it is utilized later by the recipient for receipt verification. Finally, in step 504, the ciphertexts t and the DS t₁ (alternatively t₁ may be publicized), are transmitted to the recipient. The sender has two options. The first is to send t₁, and the second is to leave t₁ publicized (in his site) as a signature for message number m, for instance. The verification procedure V may also be left publicized by the sender or transmitted over the channel. The sender can choose the same verification procedure V for all DSs. Alternatively, a verification procedure V is constructed differently for each message, in order to increase security. However, in such a case, the sender should maintain and publicize a list of verification procedures in which each message is given a corresponding verification procedure. This may be substantially alleviated by adopting a compact verification procedure which depends in an accumulated way on previous noises and/or plaintexts or in general previous stochastic ingredients.

The recipient receives the transmission, step 505, and in steps 506 the cipfertexts t and the DS t₁ are decrypted. After the decryption of both ciphertexts the recipient knows all the ingredients of V and the verification can be carried out. The verification process, step 507, is comprised from a comparison between the verification parameters in V and the noise signals, nₐ and nₐ₁, which results from the decryption. If the comparison yields a match, then messages' authentication, and the sender identification is guarantied.

In this fashion, for a one-time signature scheme the channel is secure. The usefulness of these signature schemes is: (a) The signature/verification procedure is very easy to implement with complexities of O(N); (b) A plaintext repeated twice has in each transmission a different signature due to the different private-noise. Such a time dependent signature may be used to identify the time (or stamping) that the sender/recipient first encrypt/decrypt the message. The main drawback of the above signature scheme is that a legal plaintext can be easily forged. There are exponentially many plaintexts s and private-noise nₐ, and nₐ₁ which give the same verifiable vector V and each of them can be constructed with O(N) steps. It should be noted that in a parallel embodiment of the belief algorithm, the complexity is significantly reduced to approximately O(1).

An advanced secure signature is one in which the sender first generates a vector V (whose dimensions are N×1) from a combination of s and/or nₐ following a public protocol. Next, the number of non-zero elements in V is truncated to a fixed number K following the sender's public protocol (For rare events in which there are insufficient 1's in V, the sender provides a special procedure). For instance, this may be accomplished by flipping non-zero elements. For illustration, the most simple scenario is; starting from the beginning of the vector V, and proceeding until the number of non-zero elements equals K (Of course it is easy to construct a procedure which is less spatially structured, meaning that in the above illustration the probability for a bit to be flipped in generating V is higher when we are in the beginning of the ciphertext). The signature [Êₖ]V is left publicized by the sender. Determining V from the knowledge of [Êₖ] and the signature is known to be an NP-complete problem. The recipient, who knows s and nₐ, can easily verify the signature. (In general, the number of non-zero elements may be fixed to be less than or equal to a constant K This problem is known as NP, too). Following the above procedure, it is possible to generate the signature with a truncated version of the public-key. In such a case the rows of [Êₖ] that correspond to the non-zero elements in V (in general, one can eliminate any set of rows, for instance, the rows of three successive zeros) that were truncated, are also truncated from [Êₖ]. Optionally, a private noise signal may be added to the signature, but in such a case, the public-key [Êₖ] should be utilized to generate the signature, without any truncations applied to it.

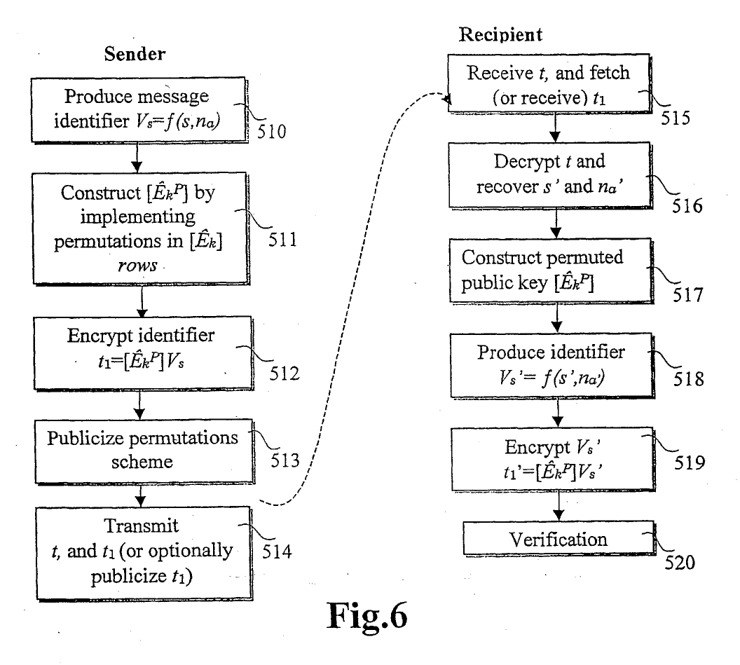

FIG. 6 is a flow chart illustrating another advanced secure signature based on the public key [Êₖ]. A message identifier, Vₛ, is produced in step 510 from a combination of s and/or nₐ (f represents a function for producing said identifier). In the next step, 511, the rows of the public key, [Êₖ], are permuted to implement a permuted public key [Êₖ^{P}]. The permutations among the rows of [Êₖ] are implemented as a function of the detailed structure of s (and/or nₐ). For instance, one can exchange/permute, any rows corresponding to successive 1's in Vₛ, or any other permutation which is less spatially correlated. The recipient knows the manner according to which Vₛ is obtained.

In the next step, 512, the DS t₁ is produced by the encryption of the message identifier Vₛ with the permuted public key [Êₖ^{P}]. Then, in step 513, the sender publicizes the permutation scheme that was utilized to produce the permuted public key, [Êₖ^{P}]. However, in a possible embodiment of the invention, said permutations can be time-dependent, as the public key [Êₖ], so that step 513 is only optional. The ciphertext t and the DS t₁ are transmitted to the recipient in step 514. The transmittal of the DS t₁, as was explained before, is optional, and the DS may be publicized instead (at the sender site, for instance).

The recipient receives t and t₁ (or fetch t₁ if it was publicized) in step 515, and then in step 516, the message s′, and the private noise nₐ′ are recovered by decryption of the ciphertext t utilizing the belief algorithm. In step 517, the recipient construct the permuted public key, [Êₖ^{P}], guided by the structure of the plaintext s′ (and/or noise signal nₐ′), and by the permutation scheme that was publicized by the sender (in step 513). In the next step, 518, the recipient produces a message identifier Vₛ′ following the public protocol and utilizing the recovered information s′ and nₐ′. In step 519 the identifier Vₛ′ is encrypted to establish the recipient version of the DS, t₁′. Finally, in step 520, a verification process is carried out, in which the two encrypted DSs, t₁ and t₁′, are compared. If the encrypted DSs, t₁ and t₁′, are identical then the verification is completed successfully, assuring source identification. However, if said DSs are slightly different, as noted above, it is sufficient for high percentages of bits in t and t₁ to be the same. In this way, a more reliable procedure is obtained, especially in cases wherein the belief algorithm failed to recover the noise exactly.

Since the DS depends on s and nₐ, and on [Êₖ], the same plaintext transmitted to different addresses or at different times (with different private noise signals nₐ) is characterized by different signatures. It should be understood that with this method, an on-line encryption system is dynamically constructed. The resulting DS is always different, even when produced several times for the same message s.

It is also plausible that the DS is very long, even much longer than the ciphetext, and the recipient fetches part of it following the required confidence. When decryption is performed in the case of a permuted public-key, permutations of the matrices [A] and [B] are utilized. Matrix [A] is identical to its permutation, [Aₚₑᵣ]=[A], while matrix [B] is permuted the same way the public-key [Êₖ] was permuted, but instead of permuting its rows, [Bₚₑᵣ] is obtained by permuting matrix [B]'s columns.

Since the potential eavesdropper does not know s, nₐ and [Êₖ], the task, to disrupt the transmission is very difficult. The lack of an independent permuted public-key as a function of the plaintext seems to make the work of a disrupter even harder. In general, one can make the situation even more complex. A new noise signal, nₐ₂, may be added to the DS t₁ in step 512, resulting in a new DS c₂. Then, said new DS c₂ is publicized instead of t₁. In this case, in step 519, in addition to encrypting Vₛ′, the belief algorithm should be applied to separate t₁ from c₂, before performing verification. Another possible embodiment of the invention may be one in which the recipient determines a detailed permutation scheme to be applied to the public key. This will make the decryption (decoding) step standard.

The aim of the authentication procedure is to keep the integrity of the message constructed from a sequence of plaintexts, such that an eavesdropper cannot forge (add/delete) cipher-texts. By using error-correcting codes as a cryptosystem, this goal can be achieved by utilizing correlated noise for successive ciphertexts. For instance, a method for obtaining successive correlated noise signals may be one in which the noise signal that is utilized to encrypt the next block is a cyclic permutation of the previous one, or part of it, that is chosen at random, and the rest of it is a one bit shifted of the pervious one.

Utilizing the authentication scheme of the invention, the recipient has only to decrypt the first plaintext, whereas the rest of the message is uniquely defined, since the noise is known. On the other hand, The eavesdropper knows the authentication scheme and may concentrate only on the decryption of the first ciphertext. Alternatively, the decryption by the eavesdropper of an intermediate plaintext (the easy one) immediately reveals the successive plaintexts. In order to ensure the same security of (almost) all plaintexts, one can use accumulated permutations. The private-noise for the current ciphertext depends on all previous plaintexts and/or private-noise utilizing a publicized procedure by the sender or by the recipient. This yields a different authentication scheme for different messages, and from the same message transmitted at different times, or addresses.

In another embodiment of the present invention both noisy plaintext and ciphertext are utilized in the encryption. FIG. 8 is a flow chart illustrating a process for the encryption/decryption (which may be extended also for the DS and other tasks of the secure channel) according to another embodiment of the invention. A message s (plaintext) for transmission is composed in step 800, and in step 801, two noise signals are generated, n and n₁=f(n) (n of length M and n₁ of length N).

The private noise signal n may be generated in any preferable way as was previously discussed above. The noise signal n₁ is generated by performing bit manipulation to the bits of the private noise signal n following a known procedure (i.e., predetermined, or publicized by the sender or the recipient), as will be exemplified later. In step 802, the noise signal n₁ is added to the message s, and a noisy message sₙ=s+n₁ (mod 2) is obtained.

The new signal sₙ is encrypted in step 803, to obtain the ciphertext C—

C=[Eₖ]sₙ=[Eₖ](s+n₁) (mod2).

Before the ciphertext C is transmitted in step 805, the private noise signal n is added to the ciphertext C, in step 804. Therefore, the transmitted signal r, is now—

r=C+n=[Eₖ]sₙ+n=[Eₖ](s+n₁)+n (mod2)

The noise n₁ added to the plaintext s, in step 802, is a function of the noise n added to the ciphetext C, in step 804. More particularly, n₁=f(n) is obtained by manipulating the bits of the noise signal n (including all Boolean operations and permutations among the bits) following a scheme which is known (public scenario) to both, the sender and the recipient.

The process of obtaining n₁ from the knowledge of n may be determined and publicized either by the sender or the recipient. Alternatively, such a process may follow the particular structure of the private noise signal n (or the noisy plaintext sₙ). For example, one may repeat each non-zero element in the private noise signal, n, by 1/(4f) successive non-zero elements, starting from its location i, and backward, by repeating non-zero elements starting from M−i (thereby obtaining a more dense noise signal wherein the fraction of non-zero elements is close to ½).

After receiving the transmission r, step 811, the recipient decrypts the transmission r utilizing his private key Dₖ=[A,B], in step 812. The decryption results reveal both the noise signal n and the noisy plaintext sₙ. Then in step 813, the recipient determines the private noise n₁=f(n) by following the publicized procedure of obtaining n₁ from n. The process is concluded as the plaintext is revealed, in step 814, by the simple subtraction s=sₙ−nₗ (mod 2).

One may easily find a linear construction in which n₁ is dense where the number of non-zero elements is close to a fraction ½. (as exemplified here above). Hence, the average fraction of flipped bits in sₙ in comparison to s is ½. The probability of constructing the appropriate partial public key [Eₖ^{part}], which reveals the plaintext without guessing the correct noise, falls of as 2^{-N} (as for a random sequence).

Hence, in any effective attack one has to check all possible locations for the noise, and in practice one can work with a much lower level of noise. The method of constructing partial public key corresponding to non-flipped bits does not help in the case of noisy plaintext. One has to know the location of the flipped bits. Furthermore, working with lower noise level opens a larger gap to the maximal allowed operating noise level. This gap can be filled by real noise added during the transmission such that the system can be used for both cryptosystem and as an ECC against additive noise occurring during the transmission. It should be also noted that the noisy plaintext enables to work with high security together with a shorter plaintext. Hence, in practice one can work also with dense public key.

In principle, the publicized recipe for n₁ may depend on both sₙ and n, n₁=f(n,sₙ), as was previously described above for digital signature. It should be clear that since all the additional operations regarding n₁ scale linearly with the size N of the plaintext s, the linear complexity of the encryption/decryption process is not altered. In addition, all the additional time-dependent ingredients may still be utilized for DS and authentication as it was described here above.

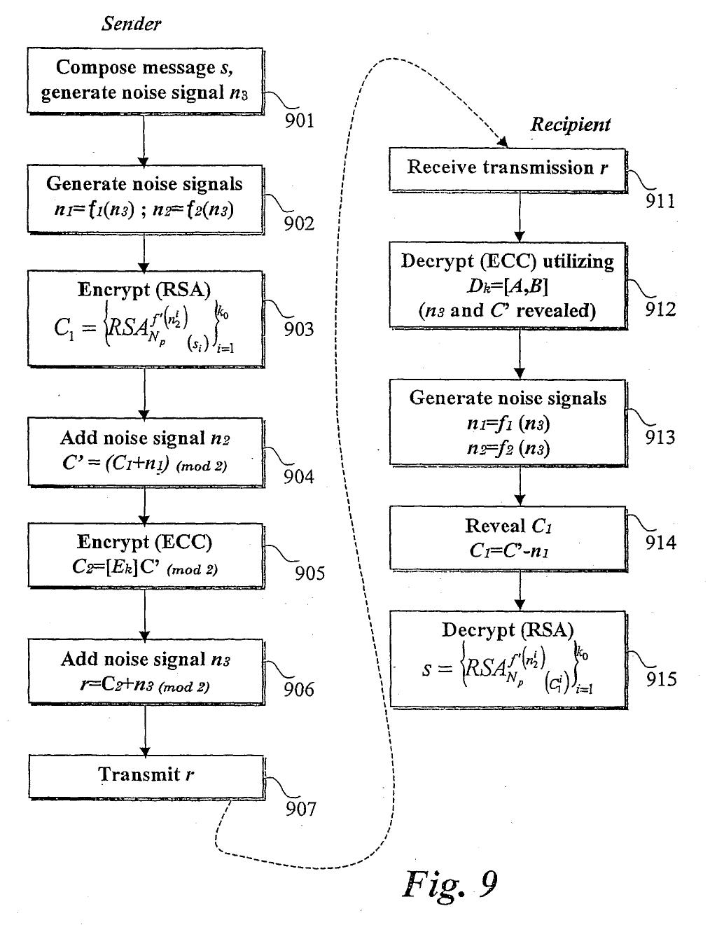

In another embodiment of the invention, illustrated in FIG. 9 in the form of a flow chart, the encryption is of two layers. The first layer of the encryption efficiently utilizes traditional encryption methods, such as RSA, and the second layer is carried out utilizing an error correction code. In this method the public key consists of three portions. The first one is [Eₖ] as before, the second one consists of the directions for constructing n₂ and n₃ of rank M, and the third part consists of a series of RSA public-keys of length Nₚ each—

{RSA_{N}_{ₚ}¹,RSA_{N}_{ₚ}², . . . ,RSA_{N}_{ₚ}^{k}^{₂}}.

In the first step, 901, the sender composes a plaintext message s, and a private noise signal n₃. The length of the private noise signal n₃ should be the same as the resulting ciphertext C₂ (i.e., M bits long), as will be understood later. In the next step, 902, additional noise signals n₁ and n₂ (of ranks N and M respectively), are generated from the private noise signal n₃, by following publicized procedures n₁=f₁(n₃) and n₂=f₂(n₃). In step 903, RSA encryption (first layer) is performed to equal length blocks sᵢ (i=1,2, . . . ,k₀; k₀=N/Nₚ) of the plaintext s. For that purpose a set of k₂ different public keys RSA_{N}_{ₚ}ⁱ;(i=1,2, . . . ,k₂) are utilized, each of which is of the length Nₚ.

Encryption in the first layer (step 903) therefore consists of k₀ operations of RSA encryption, performed to a set of equal length blocks sᵢ of the plaintext s={s₁,s₂, . . . ,sₖ₀} to obtain the ciphertext C₁—

$${C}_{1} = \{ {RSA}_{{N}_{p ( {s}_{1} )}}^{{f}^{′} ( {n}_{2}^{′} )} , … , {RSA}_{{N}_{p} ( {s}_{2} )}^{{f}^{′} ( {n}_{2}^{′} )} , … , {RSA}_{{N}_{p} ( {s}_{{k}_{0}} )}^{{f}^{′} ( {n}_{2}^{′} )} ] ; {k}_{0} = \frac{N}{{N}_{p}}$$

The encryption key RSA_{N}_{ₚ}^{f′(n}^{₂}^{¹}⁾ utilized to encrypt each planetext sᵢ is chosen from the set of k₂ keys—RSA_{N}_{ₚ}¹, RSA_{N}_{ₚ}², . . . ,RSA_{N}_{ₚ}^{k}^{₂}. To obtain block encryption with different sequences of the same keys, the encryption keys are chosen utilizing an indexing scheme f′(n₂ⁱ);(i=1,2, . . . ,k₀) based on the noise signal n₂. For instance, one may choose an indexing scheme f(i)=mod(n₂ⁱ, k₂)+1. In the above example, n₂ⁱ stands for the binary representation of the bits └(i−1)·Nₚ+1,i·Nₚ┘ in n₂, and mod is the k₂ modulus of this bits plus 1 which gives an integer between 1 and k₂.

Alternatively, one may take n₂ⁱ to be the binary representation of consecutive blocks of k₂ bits in n₂ (i.e., the [(i−1)·k₂+1,i·k₂] bits in n₂), and the indexing scheme to be guided accordingly by the rounded results of log₂(n₂ⁱ+1)+1 (i.e., rounding the result to the closest integer).

Noise signal n₁ is then added to the ciphertext of the first layer C₁ to obtain C⁰=(C₁+n₁) (mod 2), in step 904. Then in step 905, a second layer of encryption is performed to obtain the ciphertext C₂=[Eₖ]C⁰. The process proceeds to step 906, in which the noise signal n₃ is added to the ciphertext of the second layer C₂ to obtain the final signal r=C₂+n₃ (mod 2) to be transmitted in step 907.

The recipient receives the transmission r in step 911, and following receipt, decryption of the second layer is performed in step 912, utilizing the private key Dₖ=[A,B]. Second layer decryption reveals the private noise signal n₃, and the noisy ciphertext C⁰. In the following step, 913, the recipient generates the noise signals, n₁ and n₂, utilizing the private noise n₃ and the publicized schemes by which those signals were generated, f₁ and f₂.

The ciphertext C₁ may be easily revealed now by subtracting n₁ from C⁰, as illustrated in step 914. The decryption is completed by performing a set of k₀ operations of RSA decryption, utilizing the set of private keys RSA_{N}_{ₚ}ⁱ;(i=1,2, . . . ,k₂) following the noise n₂. Again n₁ and n₂ can be chosen to be dense and all operations related to these additional ingredients may be chosen to scale linearly with N.

It should be clear that the RSA encryption is only an example and in general it can be replaced by any standard method. The main idea here is using non-linear cryptosystem in the first layer, utilizing short blocks without altering the security of the channel. It should be noted, however, that in the above, one may choose two identical noise signals n₁=n₂ (i.e., f₁=f₂).

The noise signal n₁ plays a crucial role in this method. With the lack of n₁ the opponent may try to reveal the plaintext, by first guessing a partial invertible portion of the public-key [Eₖ]⁻¹, and then all k₂ possible short RSA_{Np}, (which can easily be broken for small Nₚ). Although the revealed plaintext will be slightly noisy in this method, due to n₃, most of the plaintext will be recovered. Furthermore, the probability that two different RSA_{Nk} will generate legal text (up to a small noise) is negligible. In order to ensure that all the k₂ different RSA will be chosen with equal probability, a dense (or heavily dense) n₂ is preferred.

The complexity of the encryption/decryption process is dominated by the behavior of the RSA complexity but with the reduced size from N to N/k₀. Therefore, one may easily combine traditional methods with this new linear and secure system. The RSA method is brought here only to exemplify the method of the invention, of course any other acceptable method may be used for the first layer.

In the RSA method, the complexity for-the generation of a new code scales as O(N⁴) where N is the size of the plaintext. With the method of the invention the complexity for the generation of a new code is mainly dominated by the complexity of inverting the matrix [B], which is bounded from above by O(N³) for a dense matrix. However, for sparse matrices [B]/[B⁻¹] the complexity of inverting the matrix [B] is typically O(N²). Hence, an advantage of the method of the invention is that the cryptosystem may be easily designed to be time-dependent. For some constructions of sparse matrices, the complexity of finding the inverse matrix can be reduced even further to O(N) (i.e., to scale linearly with the size of the plaintext) and the modular block matrices along the diagonal is only one simple example. Another possibility is to change only a small number of elements in the matrix [B] from 0/1 to 1/0. In this case, wherein the matrix is perturbed only slightly, the complexity of finding the inverse matrix from the knowledge of the unperturbed matrix is much simplified.

In another embodiment of the invention, one may use the same noise signal for a long message s constructed from a sequence of blocks sᵢ (i=1,2, . . . ,k′). The decryption of the first block s₁ is carried out as was described above, following one of the methods of the invention. However, for the rest of the message S₂, . . . ,s_{k′},since the noise in known, instead of solving the equation Z=[A]s+[B]n for unknown s and n, one has now to solve Z′=Z−[B]n=[A]s, only for s. This equation for Z′ can be solved either by belief propagation, for instance, or it can be shown to be equal to the product of a matrix with a vector (like linear filtering), using standard matrix algebra.

It is important to note that when utilizing the same noise for all the sequence of blocks, sᵢ(i=1,2, . . . ,k′), one can simply work with a rate that equals to one, as will be described here after. The encryption of each block is obtained from the product of the noisy plaintext by a matrix [E₁] of the size N×N, where the noise added to the plaintext is a vector of rank N (obtained from the fixed noise of length M, which is added to the first block). The decryption is obtained from the product of the received message by the inverse matrix [E₁]⁻¹. It should be noted that both [E₁] and its inverse [E₁]⁻¹ can be chosen to be sparse, or even to be a fixed universal matrix which is used by all the users in the network.

It is of course recommended to choose sparse matrices, which their inverse is also, a sparse matrix. Another (even simpler) possible embodiment is one in which the noisy plaintext is transmitted solely. The first block s₁ is encrypted utilizing one of the methods that were described here, utilizing an ECC for encryption, and a private noise signal for ciphering. The encryption of all other blocks s₂, . . . ,s_{k′}, is simply carried out by adding the private noise signal (utilized for the ciphering of the first block) to each of the other blocks s₂, . . . , s_{k′}. Since the noise added to the plaintext is dense, the level of security remains unaltered.

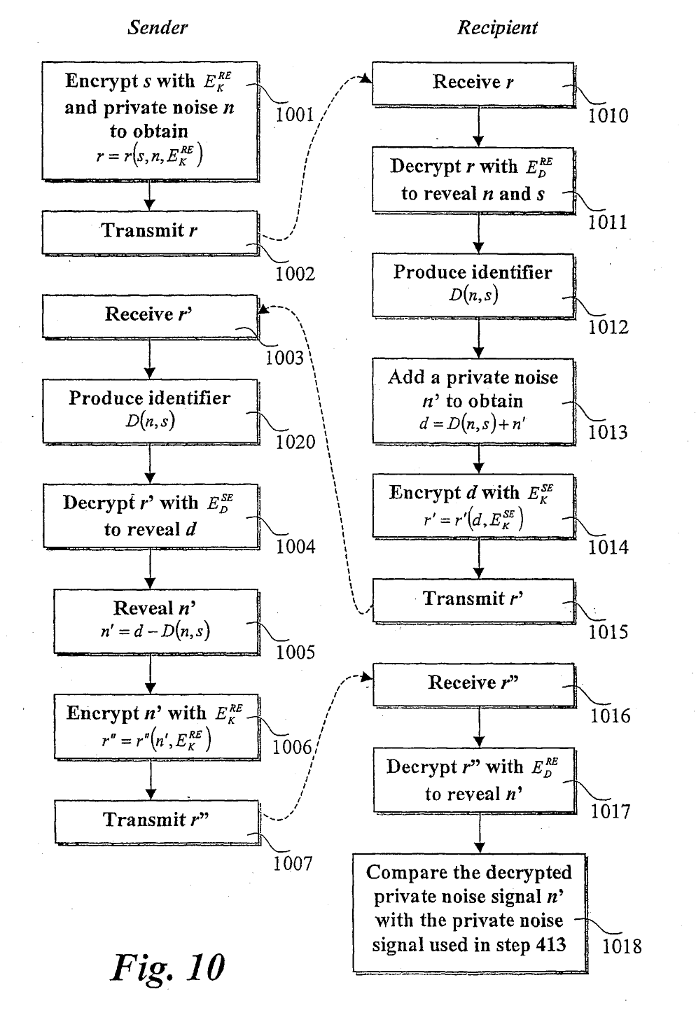

FIG. 10 is a flow chart illustrating a method for a DS according to another embodiment of the invention. A message s is encrypted, in step 1001, utilizing the recipient public-key E_{K}^{RE}, and private noise n, utilizing one of the methods that were previously described. The encrypted message r=r(s,n,E_{K}^{RE}) is transmitted in step 1002, and received by the recipient, in step 1010. Upon receipt, in step 1011, the recipient decrypts r utilizing his private-key E_{D}^{RE}, thereby revealing the plaintext s and the sender's private noise n.

In the next step, 1012, the recipient produces an identifier D(n,s) by following a procedure (which is also known to the sender) in which the plaintext and the sender's private noise are utilized. This identifier may be comprised from the sender's private noise solely. Or alternatively, a sophisticated identifier may be produced from a linear combination of the plaintext s and the sender's private noise n, or by performing some permutations and/or bit manipulation to those signals (or to one of them) or to their combination.

In the next step, 1013, the recipient adds his private noise n′ to the identifier D(s,n), to obtain a modified identifier, d=D(s,n)+n′. The modified identifier, d, is then encrypted in step 1014 utilizing the sender's public-key E_{K}^{SE}, thereby obtaining the encrypted identifier, r′=r′(d,E_{K}^{SE}). The encrypted identifier, r′, is transmitted to the sender in step 1015, and received by the sender, in step 1003.

In order to proceeds the sender has to reveal the recipient's private noise n′. Therefore, in step 1020 the sender produces the identifier D(n,s) following the (known/publicized) procedure utilized by the recipient in step 1012. However, the original plaintext s and the private noise n are utilized in this case. The sender decrypts r′, in step 1004, utilizing his private-key, E_{D}^{SE}, thereby revealing recipient's modified identifier d. The sender can now reveal the recipients private noise n′, as described in step 1005, simply by subtracting the identifier D(n,s) from the modified identifier that was obtained in step 1004. In the next step, 1006, the sender encrypts the recipient's private noise n′, utilizing the recipient's public-key E_{K}^{RE} to produce r″=r″(n′,E_{K}^{RE}).

This DS procedure may be implemented to be even more sophisticated by adding private noise signals to the encrypted identifiers ,r′ and r″ in steps 1014 and 1006 respectively. This private noise signal will be later revealed, due to the ECC feature of the cryptosystem, and the verification will conclude as it was originally described.

The sender transmits r″ to the recipient in step 1007, and it is received by the recipient, in step 1016. The recipient can now complete the verification by decrypting the transmission r″ with his private-key E_{D}^{RE}, step 1017, to reveal his private noise signal n′. Finally, in step 1018, the recipients verifies the sender's integrity by comparing the private noise signal obtained in step 1017, and his original private noise that was utilized in step 1013.

In such methods, neither the sender or the recipient, do not need to publicize an identifying information in order to allow verification. Instead, the two parties utilize a known (or publicized) procedure, according to which an identifier is obtained, utilizing information, which is in their reach. One of the outstanding advantages of such DS schemes is that a unique identifier of the message source is based on time dependent ingredients, noise signals and plaintexts, besides the private key of each of the participating parties in the secure channel system.

In view of the above-mentioned advantages, one attractive example for implementing the method of the invention will be described herein. In this implementation, it is desired to protect the information stored on a computer's hard disk from being tampered with by unauthorized users on the same computer, hackers, etc. This is simply achieved by decrypting the files in the hard disk using the method of the invention, as well as other methods. In such an implementation, the user has both the private and the public keys (which also are private).

It should be noted that this method may be used to defend the computer's operating system from damages that may be caused by cookies and other possible attacks. In such circumstances, the public key and the private keys may be kept as a file in the computer; and/or on a diskette, (as an immobilizer in cars, but with the advantage that one can easily change it from one immobilizer to another). Alternatively, the cryptographic keys may be split between two or more computers, such that it is plausible to recover the code only from all of them or part of them. For instance, let us assume that the code is split among 5 computers wherein the code can be constructed from any 3 of them.

Another possible embodiment utilizing the method of the invention may be exploited to initialize a secret communication channel, by encrypting and sending the communication parameters to the recipient, utilizing the method of the invention. For example, in certain types of Turbo codes (e.g., non-recursive), a range of 2N (for an N bits long message) parameters (numbers) are utilized to define the code with rate ½. The sender chooses a set of 2N numbers defining the desired Turbo code. To initialize the communication channel, the set of 2N numbers, defining the codes, are encrypted and transmitted via the channel, utilizing the public-key [Eₖ] and a private noise signal to encrypt (conceal) the transmitted data. The recipient decrypts the transmission, and utilizes the 2N numbers or parameters to initialize the Turbo code. (if more than 2N bits are required to represent the 2N parameters, than more than one block is required to submit the parameters).

It is important to note that this method is applicable to all other methods of ECC, including other versions of the Turbo code, recursive, irregular, and of different rates, and also other methods of ECC wherein the method is based on a list of parameters which define the code among a huge class of possible ECC prescriptions.

The private noise is revealed by the decryption of the ciphertext, as was discussed earlier. One may utilize the private noise signal, as well as the numbers defining the Turbo code, to enhance the security of the communication channel. For instance, they may be used for DS, authentication, or alternatively, to create a noisy plaintext prior to the Turbo ECC or to create a successive set of noise dependent on the previous noise and/or plaintexts. Another possibility is to identify the time dependent spread spectrum following the time dependent ingredients of the method, such as the noise.

It should be noted that the dynamical Spread Spectrum may be also used to improve the capacity and efficiency of the channel in the case of a communication network, wherein the spreading code (numbers) and types of subscribers participating in the network, fluctuate over time. For instance, in case of limited bandwidth, one may give a fixed spread spectrum for each subscriber of the communication network. However, in such events an overlap among the transmissions of different subscribers may occur, since at any given time the type and the number of subscribers fluctuates. Therefore, utilizing the method of the invention, a scheme for a time-dependent spread spectrum, as well as time dependent ECC, may be easily implemented. This will also help to reduce the overlap among the users and therefore enhance the channel capacity. It should be also noted that the noisy plaintext can serve also to create permutation among the bits, which is a built-in ingredient in many ECC methods.

The time dependent ingredients of the method of the invention, and the substantial low computational effort, are making it a very attractive candidate for End-to-End Security implementations. In such implementations the transmission should remain concealed from any arbitrating devices in the network. In cellular communication, for instance, one of the main difficulties is the substantial computational effort required for ciphering/deciphering the data, utilizing standard methods. Therefore, to allow ciphering, methods of low computational complexity are utilized, and as a consequence, the security of the transmission is relatively low. Moreover, arbitrating devices in the network are deciphering the transmission received from one subscriber, and then ciphering it for transmission to another subscriber.

Utilizing the method of the invention in End-To-End security implementations will allow a relatively simple ciphering mean for concealing the information transmitted between two ends. In cellular communication networks, for instance, the method of the invention may be utilized to initiate and to configure the ECC and/or the frequency bandwidth and spectrum spreading of the communication. The time dependent ingredients (i.e., private noise signals) of the invention may be easily and efficiently utilized to randomly select the communication parameters (i.e., bandwidth, spreading code, etc.). So that the communication it self may be concealed.

It should be noted that allowing a random selection of the communication parameters would increase the system tolerance to overlaps occurring as new operating subscribers are added to the system. As a consequence, channel capacities are also substantially enhanced, and the immunity to interference.

Another plausible advantage of a noisy plaintext is to improve data compression in the following sense. Let us assume that the bit stream has some structure in it (prior knowledge of the sender, for instance, or the data has some non-trivial structure in the power spectrum). One can choose to add a special noise to the plaintext such that the data of the noisy plaintext can be better compressed than the non-noisy plaintext. In this scheme, a noise is added to the plaintext to create a noisy plaintext. The noisy plaintext is compressed and then encoded for transmission through the channel. This can be done with respect to the encrypted Turbo or any other ECC channel or in the general prescription of noisy plaintext discussed above. The advantages of this superior compression are expressed in bandwidth gain and/or in the capacity of the channel, in the cost of dealing with linear complexities, which stems from dealing with the noisy channel. The main idea here is that one may change some statistical features or create spatial correlation using the noisy plaintext.

The tasks of the cryptosystem of the invention can be extended to other functions of the secure channel, such as an undeniable signature. Let us characterize the following possible scenarios which may appear in different circumstances. In the first scenario, the sender is using an undeniable signature with/without notifying the recipient in advance or, vice versa, the recipient has a request for undeniable signatures again with/without notifying the sender in advance. The main idea is that the private-noise is added to the ciphertext such that the decryption cannot terminate successfully without the sender partially revealing the private noise. For instance, the sender can also add private-noise out of the allowed range by the recipient, or the recipient purposely defines a too large range for the private-noise, which is beyond the capability of his decryption process to ensure a successful termination. The enlargement of the regime of the private-noise can be done by the sender/recipient with/without notifying the partner.

If the DS is not transmitted with the encrypted plaintext, but instead kept publicized (in the sender's site), the sender has to keep all previous DSs as public information. The list of the signatures may load the sender resources, and furthermore it may take a long time for the recipient to find the appropriate signature among many. Removing the signature into an archive after the recipient performs verification may be one way to alleviate this drawback.

Some of the advantages of the cryptosystem of the invention over methods based on numbers theory, such as an RSA cryptosystem are: a) the matrix operations and the belief network algorithm decoding in the decryption/encryption process can be carried out and implemented in parallel; b) a one-time success by an eavesdropper (even by a prior knowledge of the plaintext) to reveal a plaintext does not automatically help or ensure the recovery of other plaintexts that the sender sent to the same recipient; c) in the RSA method the eavesdropper's task requires a check of many possible trails, where each trail can be examined by the same algorithm. Hence, the task of an eavesdropper can be easily split among many resources. In contrast, the inventions' cryptosystem is based on many stochastic ingredients with time dependent features of the sender and the recipient. Hence the strategy of the eavesdropper may need to vary between different messages and users of the channel.

As was described above, the complexity of the encryption/decryption is significantly reduced (from O(N) to O(1), wherein N is the size of the plaintext) implementing the method in a parallel embodiment. A parallel embodiment may be easily implemented, since the algorithm of the invention is based on the products of matrices and vectors (the appropriate hardware for such implementation already exists, i.e., hardware for computing vectors dot product). Another advantage of utilizing a sparse public-key [Êₖ] is that the complexity of downloading the public-key, scales linearly, since only the locations of non-zero elements ought to be transmitted.

All the method that where described here, for encryption decryption utilizing a parity check error correcting code, may be utilized efficiently to construct secure communication in which the coding rate is dynamic. More particularly, one may use a set of public-keys [Eₖ⁽ⁱ⁾] of dimensions Mᵢ×N, and a set of the corresponding private keys, to encrypt/decrypt each transmission utilizing a different pair of keys, thereby continuously changing the coding rate. To improve security, one may further utilize the private noise of the previous transmission to select the cryptographic key for the next transmission. Thereby allowing a random selection of cryptographic keys, and rates.

Alternatively one may utilize the first transmitted block to set the rate and parameters of the EEC method beside the spread spectrum parameters.

Utilizing the method of the invention, sophisticated encryption schemes may be implemented, especially in view of the above advantages. Such a scheme may be one in which the plaintext is encrypted many times with different rates, making the situation more and more complex. For instance, utilizing Q different keys, └Eₖ_{ⱼ}┘_{M}_{ⱼ}_{×M}_{ⱼ₋₁}(1≦j≦Q), each of which is of different rate,

$${R}_{j} = \frac{{M}_{j - 1}}{{M}_{j}} ( 1 \leq j \leq Q ) .$$

In this fashion, the j'th ciphertext Cⱼ is obtained as follows—

└Eₖ_{ⱼ}┘_{M}_{ⱼ}_{×M}_{ⱼ₋₁}└Cⱼ₋₁┘_{M}_{ⱼ₋₁}_{×1}=└Cⱼ┘_{M}_{ⱼ}_{×1}(1≦j≦Q),

wherein [C₀]_{N×1}=s is the original plaintext, and M₀=N is said plaintext's length.

The method of the invention is exemplified herein by the Gallager-type code. It should be clear that the invention is applicable to parity check codes in general, including MN code, and also convolutional codes. Additionally, the method of the invention may be generalized to the case of transmitting symbols (finite set alphabet), instead of bits (i.e., “0”s and “1”s), as is the case in the BSC. Thus, the invention may be implemented in many other (than the BSC) types of communication channels, such as the Gaussian channel.

The method of the invention can serve as an intermediate step in any existing method. For instance, one may first encrypt a plaintext utilizing RSA method, and then encrypt it utilizing the present invention method, utilizing an ECC. The decryption, in this case, is comprised from the method of the present invention for decryption first, and then applying “enveloped” method (i.e., RSA or any preferred method). It should be noted that the method can also serve as an ECC tool, in addition to a cryptosysytem. If a “real” noise is added to the regime of the artificial noise during the transmission, the system is capable to clean this noise up to some level (also plausible if the noise is added out of the regime of the artificial noise).

With the following ingredient, utilizing the cryptography method of the invention, makes it possible to absolutely hide the transmission itself. In this case, the opponent is unable to detect and realize that the transmission is being carried out (for instance, on Radio Frequency (RF) transmission).

It is common and useful to apply Spread Spectrum techniques in communication network, where a specific code is utilized to modulate the transmission, and later for demodulation of the received transmission.

Usually, the codes used in Spread Spectrum are public, well known and stationary. This means that they are not changing rapidly or usually not changing at all. The main purpose in using Spread Spectrum is to improve the quality of the received messages, as in FM radio communication.

The proposed Cryptosystem enables hiding the transmission itself (in addition to scrambling the information) by applying a Cryptographic time varying Spread Spectrum modulation. The Spread Spectrum modulates the transmitted signal in order to widen its spectral bandwidth or widen its time domain behavior. The receiver performs a matched demodulation to recover the original signal.

The following method is an example of utilizing the cryptographic time varying Spread Spectrum modulation:

1. Establish communication using the proposed cryptosystem without applying Spread Spectrum modulation at all or with a common (i.e. public) Spread Spectrum modulation. For instance, when utilizing a cryptosystem according to the invention method, the first plaintext (and/or the noise) includes the information on the particular Spread Spectrum modulation of the forthcoming plaintexts, the message. The first plaintext is encrypted utilizing the method of the invention, and then transmitted.

2. The receiver decrypts the plaintext and reveals the current Spread Spectrum modulation.

3. Data is sent (encrypted by the cryptosystem of the invention) through the well-established Spread Spectrum modulation link, indicating how the information is hidden (or made wider in time domain) within the spectral bandwidth.

4. From now on, the transmission is Spread Spectrum modulated in accordance with the established Spread Spectrum modulated link. The receiver demodulates the Spread Spectrum signal utilizing the data that was previously received.

When utilizing such time-dependent Spread Spectrum modulation, the time-dependent Spread Spectrum modulation can be encoded in the first transmitted block or by the structure of the additive time dependent noise, nₐ, or by any combination of the plaintexts and noise signals. Such a method is applicable as additive ingredient for all known cryptosystems, including RSA. The Spread Spectrum modulation can be varied between different transmitted blocks. For instance, the first plaintext indicates the parameters (i.e. the Spread signal) utilized for the modulation of the next block. The modulation of the third block is some linear (or nonlinear) combination of the modulation and the content of the last block. This may also be used to improve data compression on a given bandwidth. However, it should be understood that the main purpose of the Spread Spectrum modulation is to hide the communication (without replacing the cryptosystem). In addition, the Spread Spectrum modulation parameters that are encrypted in the first block can be used for the timing of forthcoming messages, by adding the time difference from the received data of the first block. More precisely, the first block in such a case will comprise the broadcasting time of the rest of the message.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A method for a secure public key cryptography employing a parity check error-correcting code, and noise signals, comprising:
a) creating a communication channel;
b) providing a set of private cryptographic keys which are assigned to each of the entities utilizing said secure public cryptography, wherein each of said private cryptographic keys may be accessed only by the entity it was assigned to;
c) providing a set of public cryptographic keys assigned to entities utilizing said secure public-key cryptography; and
d) providing a set of random private noise signals, or generating the same using a random private noise signal generator;
the method further comprising ciphering vectors of information by adding a noise signal to the information vector before encryption and/or after the encryption.

2. A method according to claim 1, wherein a fraction of the rows of the cryptographic public-key is corrupted by randomly flipping some or all of the bits in said rows, to obtain the corrupted public-key [Êₖ].

3. A method according to claim 1, wherein a message “s” is encrypted utilizing the public key of the recipient,[Eₖ], to obtain—c=[Eₖ]s.

4. A method according to claim 1, wherein a message “s” is encrypted utilizing the corrupted public key of the recipient, [Êₖ], to obtain—c=[Êₖ]s.

5. A method according to any one of claims 1 to 4, further comprising:
a) adding a private noise signal, n₁, to the encrypted message c, to obtain the ciphertext t=c+nₐ;
b) transmitting said ciphertext t to the recipient, and upon receipt of said transmission by the recipient, decrypting said ciphertext and therefore revealing the message s and the private noise nₐ; and
c) decrypting said ciphertext t, upon receipt, utilizing decryption algorithm, thereby revealing the message “s” and the private noise signal, nₐ.

6. A method according to claim 1 or 2, wherein the ciphering and the deciphering comprises:
a) providing a first vector of data s of dimensions N×1;
b) providing a private-public key for encryption, wherein said public key is the generator matrix [Eₖ] of an error-correcting code, and the dimensions of said generator matrix are M×N;
c) generating a second vector n, wherein said second vector comprising a noise signal, and the dimensions of said second vector are M×1;
d) generating a third vector n₁, of dimensions N×1, by performing permutations and bit manipulation on said second vector n, by following a known procedure;
e) generating a fourth vector of data sₙ by the Boolean addition of said first vector s with third vector n₁ to obtain sₙ=s+n₁ (mod 2);
f) generating a fifth vector C by encrypting said fourth vector sₙ utilizing said public key [Eₖ] to obtain C=[Eₖ]sₙ (mod 2);
g) generating a ciphertext vector r by adding said second vector n to said fifth vector C to obtain r=C+n (mod 2);
h) upon deciphering said ciphertext vector r:
h.1) obtaining said second vector n and said fourth vector sₙ by decrypting said sixth vector r utilizing the private key of said public key;
h.2) obtaining said third vector n₁ by employing permutations and bit manipulation to said second vector n following the same procedure used in step d); and
h.3) revealing said first vector s by subtracting said obtained fourth vector sₙ from said third vector n₁ to obtain s=sₙ−n₁.

7. A method according to claim 6, wherein the ciphering is carried utilizing the corrupted public-key [Êₖ].

8. A method according to any one of claims 1 to 7, wherein the ciphering/deciphering consist of two layers, comprising:
a) providing a data vector v;
b) providing a set of public-keys Pub^{j} and their corresponding private-keys Pri^{j};
c) dividing said data vector v into a set of k₀ data vectors v₁, v₂, . . . ,vₖ₀;
d) generating a vector n comprising a noise signal;
e) generating a vector n₂=f₂(n) following a known procedure f₂ wherein said procedure comprises permutations and bits manipulation performed to the vector n;
f) selecting an ordered set of k₂ public-keys Pub^{f′(i)} from said set of public-keys Pub^{j} utilizing an indexing scheme f′ to select the f′(i) public-key of said set of public-keys Pub^{f′(i)};
g) encrypting each of the data vectors v₁, v₂, . . . ,vₖ₀ with a corresponding public-key from said ordered set of k₂ public-keys Pub^{f′(1)},Pub^{f′(2)}, . . . ,Pub^{f′(k}^{₂}⁾ to obtain a vector s consisting of a set of encrypted vectors s={sᵢ}ᵢ₌₁^{k0}={Pub^{f′(i)}₍ᵥ₁₎}ᵢ₌₁^{k0};
h) encrypting the vector s as described in claim 6 sections a)-g) taking s as the first vector of data, and n as the second vector, to obtain the ciphertext vector r;
i) upon deciphering said ciphertext vector r:
i.1) deciphering the ciphertext vector r as described in claim 6 sections h.1)-h.3) and thereby revealing the vector n in section h.2) and the vector s in section h.3) of claim 6;
i.2) dividing the vector s into a set of k₀ vectors s₁, s₂, . . . ,sₖ₀;
i.3) generating a vector n₂=f₂(n) following a known procedure f₂ where said procedure comprise permutations and bits manipulation performed to the vector n;
i.4) selecting an ordered set of k₂ private-keys Pri^{f′(i)} from said set of private-keys Pri^{j} utilizing the indexing scheme f′ to select the f′(i) private-key of said set of private-keys Pri^{f′(i)}; and
i.5) decrypting each of the data vectors s₁, s₂, . . . ,sₖ₀ with a corresponding private-key from said ordered set of k₂ private-keys Pri^{f′(1)},Pri^{f′(2)}, . . . ,Pri^{f′(k}^{₂}⁾ to obtain a vector v consisting of a set of decrypted vectors v={vᵢ}ᵢ₌₁^{k0}={Pri^{f′(i)}₍ₛ_{ᵢ}₎}ᵢ₌₁^{k0};

9. A method according to claim 8, wherein the set of private-keys Pri^{j} and public-keys Pub^{j} are RSA cryptographic keys.

10. A method according to claim 8, wherein the noise signal n₂ is utilized to guide the indexing scheme f.

11. A method according to claim 8, wherein the indexing scheme f′(i) is determined according to the binary number n₂ⁱ represented by the i'th block of bits n₂ⁱ=[(i−1)·Nₚ+1,i·Nₚ] of the private noise signal n_{2,} where the length of said block is
$${N}_{p} = \frac{N}{{k}_{0}} ,$$
and the index of the cryptographic key is obtained from the computation of mod(n₂ⁱ,k₂).

12. A method according to claim 8, wherein the indexing scheme f′(i) is determined according to the binary number n₂ⁱ represented by the i'th block of bits n₂ⁱ=[(i−1)·k₂+1,i·k₂] of the private noise signal n₂, and wherein the index of the cryptographic key is obtained from the rounding of the computation of log₂(n₂ⁱ).

13. A method according to any one of the preceding claims, wherein the ciphering and deciphering are utilized to configure a turbo error correcting code.

14. A method according to any one of the preceding claims, wherein the ciphering and deciphering are utilized to configure other types of cryptosystems or types of error correcting codes, comprising:
a) ciphering the parameters and other data required to configure communication utilizing a known error correcting code or cryptographic method, said ciphering being according to any one of the preceding claims;
b) transmitting said ciphered parameters and other data to another participating party;
c) decrypting said ciphered parameters and data information upon receipt, to reveal said parameters and other data; and
d) initiating communications by configuring a known method according to said parameters and other data.

15. A method according to any one of the preceding claims, wherein the public-key [Eₖ] and the private-key are uniquely derived utilizing two sparse matrices [A] and [B], comprising:
a) providing a first sparse and Boolean matrix [A] of dimensions M×N;
b) providing a second sparse and Boolean matrix [B] which is invertible and of dimensions M×M;
c) deriving the cryptographic public-key, [Eₖ], from the matrix multiplication result [Eₖ]=[B]⁻¹[A]; and
d) constructing the cryptographic private-key, [Dₖ], from said pair of sparse matrices, [A] and [B], to obtain [Dₖ]=[A,B].

16. A method according to claim 15, wherein the second sparse and Boolean matrix [B] is a diagonal matrix comprising a set of k=O(N) square and Boolean sub-matrices wherein each of said sub-matrices is invertible.

17. A method according to claim 15, where the non-zero elements in the sparse matrices, [A] and [B], are randomly located within each of the sparse rows.

18. A method according to any one of claims 15, wherein the average connectivity of rows and/or columns of the second sparse and Boolean matrix [B] are equal or greater than 2.

19. A method according to claim 15, wherein the second Boolean matrix [B] is a diagonal matrix comprising a set of k=O(N^{α}) (α<1) square and Boolean sub-matrices wherein each of said sub-matrices is invertible.

20. A method according to claim 15, for producing a set of different public keys by performing permutations of the rows/columns of the sparse matrix [B] and/or matrix [B]⁻¹.

21. A method according to claim 15 where, [B]⁻¹, the inverse of the sparse matrix [B] is also sparse.

22. A method according to claim 15 where the derived public-key, [Eₖ]=[B]⁻¹[A], is also sparse.

23. A method according to claim 15 where the average connectivity of the derived public-key, [Eₖ], is less than 2.

24. A method according to claim 15, further comprising construction of sparse matrices [A] and [B] comprising:
a) constructing matrix [A] from groups of sparse rows where the number of non-zero elements in the rows belonging to a specific group of said groups is fixed and predefined; and
b) constructing matrix [B] from linear-independent sparse rows where each of said rows belongs to a group of sparse rows, and where the number of non-zero elements in the rows belonging to a specific group of said groups, is fixed and predefined.

25. A method according to claim 15, further comprising performing permutations in the order of the sparse matrices rows, [A] and [B], where said permutations may be performed arbitrarily to obtain new sparse matrices.

26. A method according to any one of the preceding claims, further comprising constructing a time dependent cryptographic key scheme wherein the time dependent components of each transmission, the private noise signal and/or the transmitted information, are utilized to choose the cryptographic key of the next transmission.

27. A method according to any one of the preceding claims, wherein the same noise signal is utilized for ciphering a set of data blocks.

28. A method according to claim 27, wherein the ciphering and deciphering comprises:
a) providing a vector of data;
b) dividing said vector of data into an ordered set of blocks of the same length;
c) ciphering the first block of said ordered set of blocks utilizing a noise signal and a public-key, as described in any one of claims 1 to 6;
d) ciphering all other blocks of said ordered set of blocks, apart from said first block, by adding said noise signal to each of said other blocks, thereby obtaining a set of ciphered blocks from said set of ordered blocks;
e) upon deciphering said set ciphered blocks:
e.1) deciphering the first block of said set of ciphered blocks utilizing the private-key, thereby revealing the content of said first block, and said noise signal; and
e.2) deciphering all the other ciphered blocks of said set of ciphered blocks, apart from said first block, by subtracting said noise signal from each of said other ciphered blocks.

29. A method according to claim 27, wherein the ciphering and deciphering comprises:
a) providing a vector of data;
b) dividing said vector of data into an ordered set of blocks of the same length;
c) ciphering the first block of said ordered set of blocks utilizing a noise signal and a public-key, as described in any one of claims 1 to 6;
d) ciphering all other blocks of said ordered set of blocks, apart from said first block, by the following steps:
d.1) encrypting each block by performing vector and matrix multiplication of the each block by an invertible matrix [E₁];
d.2) adding said noise signal to each of said encrypted blocks, thereby obtaining a set of ciphered blocks from said set of ordered blocks;
e) upon deciphering said set ciphered blocks:
e.1) deciphering the first block of said set of ciphered blocks utilizing the private-key, thereby revealing the content of said first block, and said noise signal; and
e.2) deciphering all the other ciphered blocks of said set of ciphered blocks, apart from said first block, by subtracting said noise signal from each of said other ciphered blocks; and
e.3) performing vector and matrix multiplication of the signal obtained in e.2) by the inverse matrix [E₁]⁻¹.

30. A method according to claims 27 to 29, wherein the ciphering rate is enhanced to one.

31. A method according to any one of the preceding claims, wherein the ciphering and deciphering are utilized to conceal the information stored on a storage device to allow the access to the information stored on said storage device only to entities having access to the concealing cryptographic key.

32. A method according to claim 31 wherein the cryptographic key is stored on disk or other type of magnetic or optic storage media that may be accessed via a computerized system.

33. A method according to claim 31, wherein the cryptographic key is split among a set of computer systems, connected in a network, where only a predefined number of computer systems from said set of computer systems is required in order to reconstruct said cryptographic key.

34. A method according to any one of the preceding claims, wherein encryption and ciphering are utilized to improve data compression of the transmitted information by the use of private noise signals to make changes in the statistical features of the transmission, and therefore enabling better compression of the data.

35. A method according to any one of the preceding claims, wherein the noise signal(s) of the first block(s) is utilized for random selection of the communication and/or ECC parameters required for initiating communication between subscribers in a cellular communication networks in which the transmitted data is concealed from any arbitrating devices in the network.

36. A method according -to any one of the preceding claims, wherein encryption and ciphering are utilized to construct a communication channel utilizing time dependent ECC, or spread spectrum techniques, comprising a scheme according to which the parameters to establish said ECC or said spread spectrum code are transmitted with the first block(s), or selected in accordance with the content of the private noise signal of the previous transmission(s), thereby establishing a dynamic spread spectrum scheme or ECC encoding/decoding.

37. A method according to any one of the preceding claims, wherein the coding rate is continuously changed by utilizing a set of cryptographic keys, and choosing a different key for each transmission.

38. A method according to any one of the preceding claims, wherein the private noise of previous transmission is utilized to select the cryptographic key utilized for the encryption/decryption of the next transmission(s).

39. A method according to any one of the preceding claims, where said noise signal is obtained from a fixed set, or where said noise signal is time dependent and obtained by some manipulation performed to the content the disc or another computer device, or alternatively, where said noise signal depends on the environment, or was directly typed by the user.

40. A secure channel system according to any one of the preceding claims, which is a public-key cryptosystem.

41. A secure channel system according to any one of the preceding claims, which is a digital signature system.

42. A method according to any one of the preceding claims, further comprising hiding the transmission utilizing Spread Spectrum techniques comprising:
a) utilizing the recipient public-key to send a ciphered message comprising the Spread Spectrum parameters that will be utilized for the transmission of the message;
b) receiving said message, deciphering said message, and revealing said Spread Spectrum parameters;
c) sending a message utilizing Spread Spectrum techniques modulated with accordance to said parameters; and
d) receiving said message and utilizing said parameters to demodulate the received Spread Signal;

43. A method according to any one of the preceding claims, wherein the parity check error-correcting code is of the Gallagar type, or any version of it like MN-code.

44. A method according to any one of the preceding claims, wherein a convolution code is utilized for the encryption process.

45. A method according to any one of the preceding claims, where the number of operations required to perform encryption and decryption is linearly scaled to the length of the message “s”.

46. A method according to any one of the preceding claims, wherein the noise signal is of fixed flip rate, or where each of the bits of said noise is of different flip in a manner known both to the sender and the recipient.

47. A method according to any one of the preceding claims, wherein the encryption is comprising successive encryption of a message [C₀]_{N×1}=s utilizing a predetermined set of Q public-keys └Eₖ_{ⱼ}┘_{M}_{ⱼ}_{×M}_{ⱼ₋₁}(1≦j≦Q) to recursively obtain the encrypted message C_{Q} as follows —└Eₖ_{ⱼ}┘_{M}_{ⱼ}_{×M}_{ⱼ₋₁}└Cⱼ₋₁┘_{M}_{ⱼ₋₁}_{×1}=└Cⱼ┘_{M}_{ⱼ}_{×1}(1≦j≦Q), which recursively decrypted by the recipient to reveal the message C_{Q} utilizing the decryption algorithm and where said decryption algorithm is performed Q time guided by said predetermined set of Q public-keys └Eₖ_{ⱼ}┘_{M}_{ⱼ}_{×M}_{ⱼ₋₁}(1≦j≦Q).

48. A method for constructing a digital signature for the ciphertext t of the message “s”, comprising:
a) producing a unique identifier, X(s,nₐ), where said identifier is the combination of modifications made to the message “s” and the noise signal nₐ that was utilized for the ciphering of said message s;
b) encrypting said identifier X with the corrupted public key [Êₖ] to obtain the encrypted identifier c₁=[Êₖ]X;
c) producing a digital signature from a combination of another noise signal nₐ₁ and the encrypted identifier t₁ to obtain the digital signature t₁=c₁+nₐ₁;
d) publicizing a verification vector V constructed from a combination of said message “s” and noise signals, nₐ and nₐ₁;
e) verifying the transmission source and its integrity by the following steps:
e.1) decrypting the received ciphertext t and the digital signature t₁ utilizing decryption algorithm and obtaining the decrypted message s′, and the decrypted private noise signals nₐ′ and nₐ₁′;
e.2) constructing a verification vector V′ following a predetermined procedure;
e.3) comparing verification vectors V′ and V; and
e.4) assuring transmission integrity and source identity when said verification are found to be identical or slightly different.

49. A method for constructing a digital signature for the ciphertext t of the message “s”, comprising:
a) producing a unique identifier, Vₛ(s,nₐ), from a combination of modifications made to the message “s” and the noise signal that was utilized for the ciphering of said message s, nₐ;
b) permuting some of the rows of the recipient public key following a permutation procedure to obtain a permuted public key [Êₖ^{P}];
c) encrypting said identifier, Vₛ, with the permuted public key [Êₖ^{P}], to obtain an encrypted signature t₁=[Êₖ^{P}]Vₛ; and
d) publicizing said permutation procedure.
e) verifying the transmission source and its integrity by the following steps:
e.1) decrypting the received ciphertext t utilizing decryption algorithm and obtaining the decrypted message s′, and the decrypted private noise nₐ′;
e.2) reconstructing the permuted public-mey [Êₖ^{P}] following a predetermined or publicized procedure;
e.3) constructing an identifier Vₛ′=f(s′, nₐ′) following a predetermined (or publicized) procedure;
e.4) encrypting said identifier Vₛ′, with the permuted public key [Êₖ^{P}] to obtain its digital signature t₁′=[Êₖ^{P}]Vₛ′;
e.5) comparing the sender's digital signature, t₁, and the digital signature of the received ciphertext t₁′; and
e.6) assuring transmission integrity and source identity when the identifiers t₁ and t₁′ are found to be identical or slightly different.

50. A method for constructing a digital signature for the ciphertext t of the message “s”, comprising:
a) producing a unique identifier V of the same dimensions of the message “s”, where said identifier is the combination of modifications made to the message “s” and the noise signal nₐ;
b) encrypting the identifier V with the public-key to obtain the digital signature [Êₖ]V; and
c) publicizing the procedure by which said digital signature was established.
d) verifying the transmission source and its integrity by the following steps:
d.1) decrypting the received ciphertext t and said digital signature utilizing decryption algorithm and obtaining the message s′, the private noise nₐ′, and said identifier V;
d.2) producing a new identifier V′ utilizing the decrypted message s′, and decrypted noise signal nₐ′, and by following same procedure utilized for the production of V; and
d.3) assuring transmission integrity and source identity when the identifiers V and V′ are found to be identical or slightly different.

51. A method according to claim 50 or 51, where the identifier is constructed from a combination of modifications made to the message “s” and the noise signal nₐ comprising flipping non-zero elements of said identifier until a predetermined number K (or less than or equal to a constant K) of non-zero elements is obtained, thereby obtaining a new identifier Vₙ;

52. A method according to claim 50 or 51, wherein the modifications comprise permutations and/or truncations and/or pasting predefined sections of the message “s” and/or the noise signal nₐ into predefined locations in each other.

53. A method according to claim 50 or 51 where said permutation procedure, according to which the public-key rows are permuted, is derived from the location of non-zero elements in the message “s” or/and the noise signal nₐ content or by another procedure guided by the structure of “s” and/or nₐ.

54. A method according to claim 50 or 51 where said permutation procedure, according to which the public-key rows are permuted, is predefined and known to both the recipient and the sender, and therefore not required to be publicized.

55. A method according to claim 50 or 51, where said permutation procedure is defined by the recipient.

56. A method for the secure public-key cryptography, substantially as described and illustrated.

57. A method for carrying out digital signatures, substantially as described and illustrated.
